(19) United States
(12) Patent Application Publication
(10) Pub. No.: US 2017/0006160 A1
(43) Pub. Date: Jan. 5, 2017

(54) INFORMATION SHARING CONTROL

(71) Applicant: Dots Communication, Inc., San Jose, CA (US)

(72) Inventors: Dhiraj Marya, San Jose, CA (US); Chiakai Hsu, San Jose, CA (US); Raymond Neil Walsh, II, San Jose, CA (US)

(21) Appl. No.: 15/201,214

(22) Filed: Jul. 1, 2016

Related U.S. Application Data
(60) Provisional application No. 62/188,434, filed on Jul. 2, 2015.

(51) Int. Cl. H04M 3/436; H04W 4/14; H04M 3/42

(52) U.S. Cl. CPC H04M 3/436; H04M 3/42153; H04W 4/14

(57) ABSTRACT

Disclosed is a system for controlling the information that is shared during electronic device communication. Devices communicate with a server and one another through a network. Requests for connections between users are received and connection records are created. Information is shared and communications are managed according to instructions specified by users.

### CROSS REFERENCE TO RELATED APPLICATIONS

This application claims a benefit of U.S. Application No. 62/188,434, filed Jul. 2, 2015, the content of which is incorporated by reference in its entirety.

### TECHNICAL FIELD

The disclosure generally relates to the field of electronic communication, and more particularly to systems, methods, and user interfaces for controlling the information that is shared during electronic communication.

### BACKGROUND

Communicating using electronic devices such as mobile devices is well known. A problem with mobile device communication is that it requires sharing contact information and other personal information, either willingly or unwillingly, to establish communication between two parties. This shared information includes, for example, a telephone number or email address. Once such information is shared, it is very difficult for the sharer to control or terminate the receiving party's ability to communicate with the sharer through the shared information. Consequently, mobile device users are often bombarded with unwanted communication without recourse.

One possible solution to cutting off unwarranted communication is to terminate the account associated with the shared information. However, this extremely burdensome and time-consuming. Moreover, it is disruptive as those that the user wishes to maintain communications with must be informed of the change in contact details and those informed must affirmatively update that information. Another solution is to use blocking features such as call blocking or spam reporting. However, the effectiveness of these features is limited even if they are established. In addition, for example, an unwarranted caller can call from an unblocked line and an unwarranted e-mailer can email from an unblocked email address.

To avoid this problem and the unfavorable solutions, many mobile device users are hesitant to share their contact information, which in turn reduces the amount of actual communication to below that which may actually be desired by the user.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1A illustrates an example embodiment of an environment for information sharing control.

FIG. 1B is a block diagram illustrating components of an example machine able to read instructions from a machine-readable medium and execute them in a processor (or controller).

FIG. 2 is a block diagram of a controlled communication server according to one embodiment.

FIG. 3 shows various modules and components of an application (app) client in accordance with one embodiment.

FIG. 4 shows various modules and components of an appless client in accordance with one embodiment.

FIG. 5 illustrates an example process for initiating a connection between an app user and an appless user of information sharing control.

FIG. 6 illustrates an example process for creating a communication channel between users of information sharing control.

FIG. 7 illustrates an additional example process for creating a communication channel between an app user and an appless user of information sharing control.

FIG. 8A illustrates various user interface elements that a viewing user can use to interact with information sharing control.

FIG. 8B shows an example user interface for initiating a connection or communication event using information sharing control.

FIG. 8C shows an example user interface for viewing and editing content items and content groups associated with a user of information sharing control.

FIG. 8D shows an example user interface for initiating a connection or transmitting (or sending) a message using information sharing control.

FIG. 8E shows an example user interface for transmitting a connection request using information sharing control.

FIG. 8F shows an example SMS message thread for a connection request received on an appless client.

FIG. 8G shows an example user interface for managing a connection with a user.

FIG. 9 illustrates an example process for creating an account and connecting a first appless user with a second appless user.

FIG. 10A shows an example user interface with messages relating to the process of FIG. 9.

FIG. 10B shows an example user interface with messages relating to the process of FIG. 9.

FIG. 10C shows an example user interface with messages relating to the process of FIG. 9.

FIG. 10D shows an example user interface with messages relating to the process of FIG. 9.

FIG. 10E shows an example user interface with messages relating to the process of FIG. 9.

FIG. 10F shows an example user interface with messages relating to the process of FIG. 9.

FIG. 10G shows an example user interface with messages relating to the process of FIG. 9.

FIG. 11 illustrates an example process for routing messages using information sharing control.

FIG. 12 illustrates an example process for delivering messages to users of information sharing control.

FIG. 13A shows an example user interface displaying a first app user's own content items shared with a first content group.

FIG. 13B shows an example user interface for displaying a first app user's content items on an app client of a second app user that is assigned to a content group.

FIG. 14 shows an example user interface for viewing and editing the content items associated with a content group.

FIG. 15 shows an example user interface for a user to edit content items associated with a content group.

FIG. 16A shows an example user interface for showing a first app user's own updated content items on an app client of the first app user.

FIG. 16B shows an example user interface for showing a first app user's updated content items on an app client of a second app user.

FIG. 17A shows an example user interface for displaying and editing the content groups to which a connected user has been assigned.

FIG. 17B shows an example message screen displaying information shared by a user to an appless user.

FIG. 17C shows an example user interface for displaying and editing the content groups to which a connected user has been assigned.

FIG. 17D shows an example message screen displaying information shared by a user to an appless user.

FIG. 18 illustrates an example process for terminating a connection between users of information sharing control.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Disclosed by way of example embodiments is an information sharing control configuration. The information sharing control configuration can be implemented as a system, method and/or a computer program product (e.g., a computer readable storage medium that stores instructions executable by one or more processing units). The information sharing control configuration in one embodiment includes a server, a network, and one or more clients with associated users. Users use clients to access the server. The server facilitates communication between clients and users. The server is adapted to receive a request from a first client that includes a user identifier of a user of the first client and content handling instructions corresponding to another user with which the user of the first client wants to establish a connection. The server receives a connection message from a client of the second user, and transmits a confirmation message to the client of the second user that includes shared contact information of the first user. In response to receiving a communication message from the device of a sending user, the server determines content handling instructions for a recipient of the message. The server executes one or more of the content handling instructions, which may include transmitting (or sending) the message to a device of the second user.

Clients may be app clients or appless clients. App clients have a client application that facilitates communication with the server. Appless clients use messaging protocols such as SMS to communicate with the server. Users use clients to communicate with other users and access other users' content items. Content items include data associated with a user. Users may send content items to the server and choose which connected users have access to each content item. Users may update content items and connections via the server.

### Example Environment

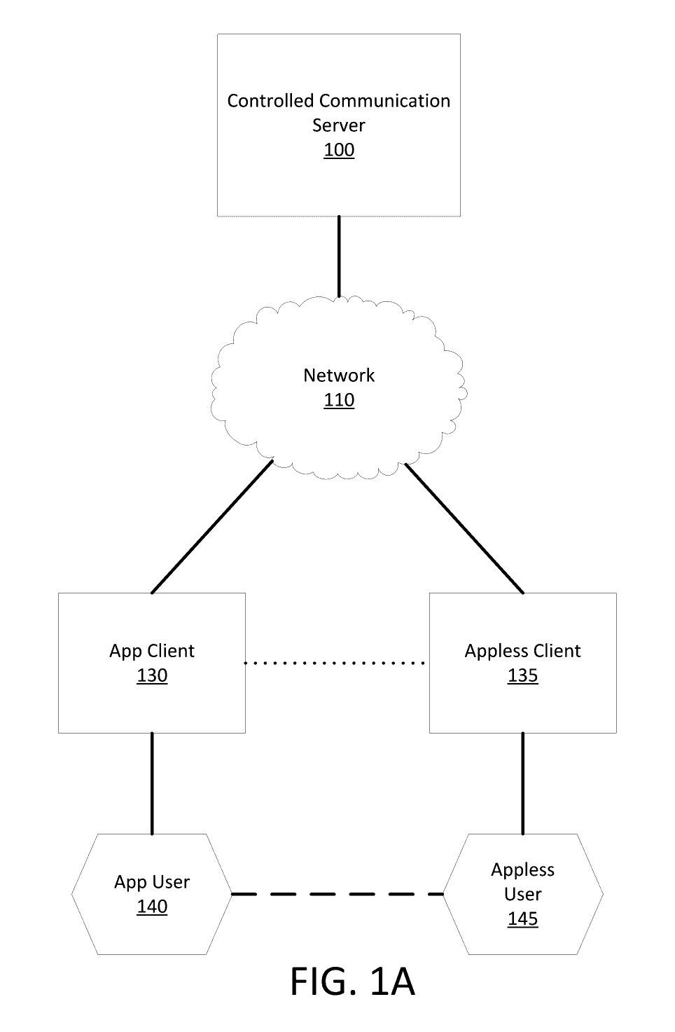

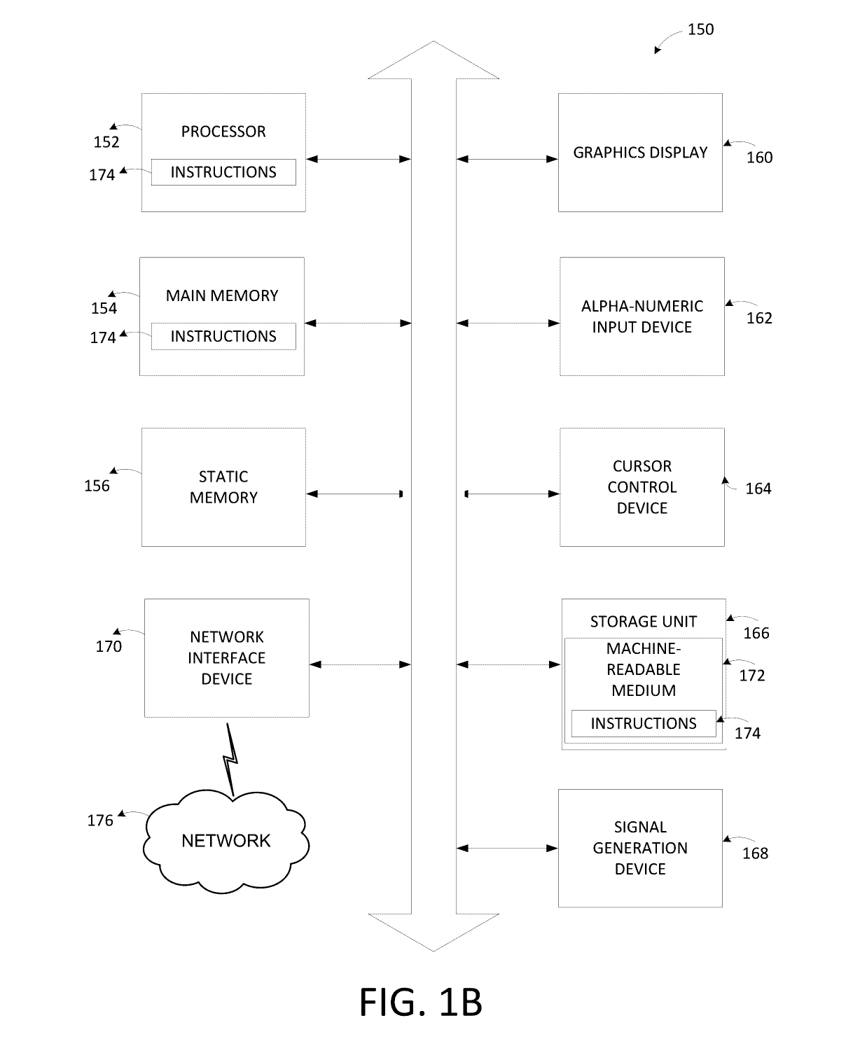

FIG. 1A illustrates an example embodiment of an environment for information sharing control. The environment includes controlled communication server 100, network 110, an (app) client 130 and an appless (i.e. does not have an app) clients 135, and one or more app users 140 and one or more appless users 145. In this example, app client 130 can be embodied as an application operating on a device configured for communication. The appless client 135 can be a device configured for communication. Note that although only two users 140 and 145 and two clients 130 and 135 are shown in FIG. 1A, this is only for purpose of illustration; in practice, any number of devices or users may be present in the environment. Similarly, other modules or components described and illustrated throughout may include single or multiple instances as appropriate to the needs of the implementer without loss of generality.

Controlled communication server 100 facilitates, via network 110, a controlled exchange of information between the users of information sharing control.

Network 110 is any suitable network and may include data and/or telecommunication networks (including mobile communication networks). In some configurations, clients 130, 135 communicate via a wired or wireless communication network to a local network service provider, and communicate with controlled communication server 100 through the Internet. In certain configurations, clients 130, 135 can communicate directly with one another without network 110 as indicated in FIG. 1A by a dotted line. For example, clients 130, 135 may communicate via a wired or wireless connection, such as wirelessly via a Bluetooth connection or a wired connection via a Universal Serial Bus (USB). In another embodiment, clients 130, 135 communicate via a cellular network.

A client 130, 135 may be an app client 130 or an appless client 135. The app client 130 may be a smartphone or other computing device that includes a software application to facilitate communication with the controlled communication server 100. An appless client 135 does not have such a software application, and may be a feature phone or other computing device that is capable of communicating with the controlled communication server 100. In some configurations, clients 130, 135 communicate with the controlled communication server 100 using a client application on the client 130, 135 or a messaging protocol (e.g., SMS, iMessage, Google Messenger, etc.).

In some configurations, appless client 135 communicates with controlled communication server 100 through a cellular network. Appless client 135 may communicate with clients 130, 135 via a cellular network. Communication may occur through SMS messaging or a similar messaging protocol. Thus, appless client 135 does not require the capability to run a particular software application to communicate with controlled communication server 100.

A user 140, 145 interacts with a client 130, 135 through one or more input devices, including a touch screen, physical buttons, a pointing device (e.g., touchpad, stylus, or mouse), and a keypad (e.g., keyboard). A user 140 may interact directly with another user 145 to share information for connecting using information sharing control. Additional configurations for this environment are described in U.S. application Ser. No. 14/660,873 filed Mar. 17, 2015 and U.S. application Ser. No. 14/660,874 filed Mar. 17, 2015, the contents of which are incorporated by reference.

### Example Machine Architecture

FIG. 1B is a block diagram illustrating components of an example machine able to read instructions from a machine-readable medium and execute them in a processor (or controller). Specifically, FIG. 1B shows a diagrammatic representation of a machine in the example form of a computer system 150. The computer system 150 can be used to execute instructions 174 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 174 (sequential or otherwise) that specify actions to be taken by that machine. Further, while only a single machine is illustrated, the term “machine” shall also be taken to include any collection of machines that individually or jointly execute instructions 174 to perform any one or more of the methodologies discussed herein.

The example computer system 150 includes one or more processing units (generally processor 152). The processor 152 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 150 also includes a main memory 154. The computer system may include a storage unit 166. The processor 152, memory 154 and the storage unit 166 communicate via a bus 158.

In addition, the computer system 156 can include a static memory 156, a display driver 160 (e.g., to drive a plasma display panel (PDP), a liquid crystal display (LCD), or a projector). The computer system 150 may also include alphanumeric input device 162 (e.g., a keyboard), a cursor control device 164 (e.g., a mouse, a trackball, a joystick, a motion sensor, or other pointing instrument), an audio input device (e.g., a microphone), a signal generation device 168 (e.g., a speaker), and a network interface device 170, which also are configured to communicate via the bus 158.

The storage unit 166 includes a machine-readable medium 172 on which is stored instructions 174 (e.g., software) embodying any one or more of the methodologies or functions described herein. The instructions 174 may also reside, completely or at least partially, within the main memory 104 or within the processor 102 (e.g., within a processor's cache memory) during execution thereof by the computer system 150, the main memory 154 and the processor 152 also constituting machine-readable media. The instructions 174 may be transmitted or received over a network 176 via the network interface device 170.

While machine-readable medium 172 is shown in an example embodiment to be a single medium, the term “machine-readable medium” should be taken to include a single medium or multiple media (e.g., a centralized or distributed database, or associated caches and servers) able to store the instructions 174. The term “machine-readable medium” shall also be taken to include any medium that is capable of storing instructions 174 for execution by the machine and that cause the machine to perform any one or more of the methodologies disclosed herein. The term “machine-readable medium” includes, but not be limited to, data repositories in the form of solid-state memories, optical media, and magnetic media.

### Example Controlled Communication Server

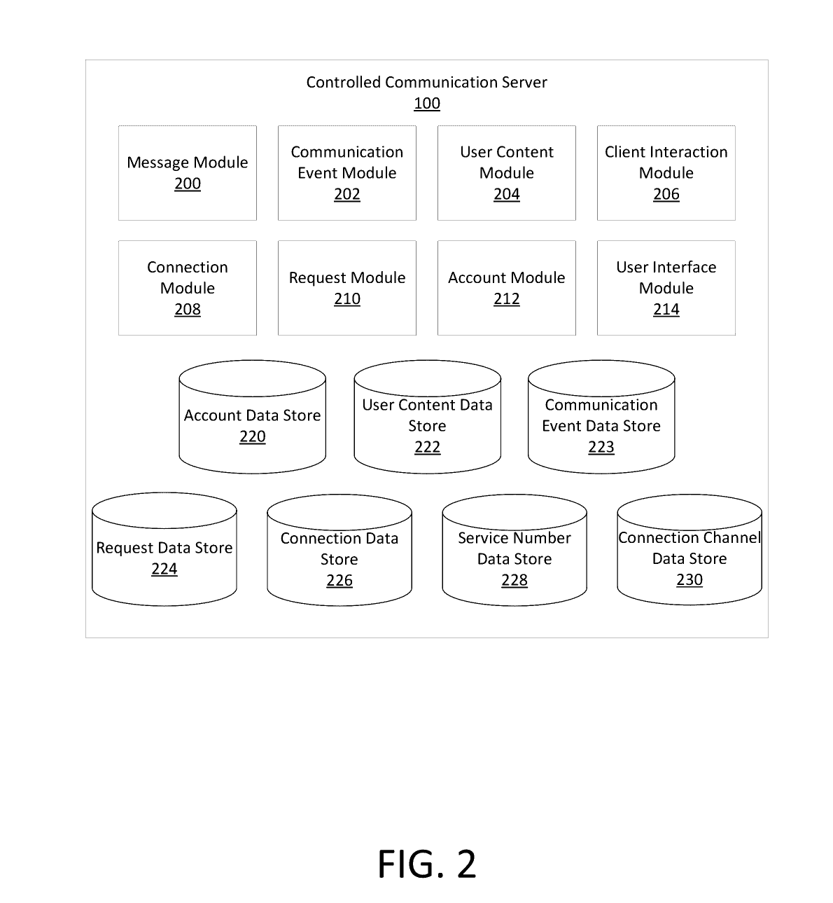

FIG. 2 is a block diagram of an example controlled communication server 100 according to one embodiment. In one embodiment, controlled communication server 100 includes message module 200, communication event module 202, user content module 204, client interaction module 206, connection module 208, request module 210, account module 212, user interface module 214, account data store 220, user content data store 222, request data store 224, connection data store 226, service number data store 228, and connection channel data store 230. In various embodiments, controlled communication server may additionally include various components of the example machine of FIG. 1B. It is noted that the modules described herein may be embodied as instructions stored in a storage device, e.g., 154, 166, and executable by a processor, e.g., 152, so that the processor, e.g., 152, is configured to perform the functions described.

Client interaction module 206 handles communications from clients 130, 135. In some embodiments, client communications may be received by message module 200, user interface module 214, or directly by client interaction module 206. In some embodiments, client interaction module 206 handles communications between clients 130, 135 and user content module 204, connection module 208, request module 210, and account module 212. Client interaction module 206 may interact with other modules in controlled communication server 100.

User interface module 214 generates and manages a user interface for the information sharing control. In one embodiment, a user can access information sharing control via a web interface generated by user interface module 214. For example, the user can navigate in a web browser on a client 130, 135 to a web address provided by controlled communication server 100.

User content module 204 receives and handles user content from clients 130, 135 and associated users of information sharing control. User content items include names, email addresses, phone numbers, physical addresses, web addresses, usernames, photographs, and important dates. In one embodiment, user content is stored in user content data store 222. User content module 204 retrieves some or all of the user content from user data store 222 when a retrieval request is received. In some embodiments, a retrieval request may come from a client 130, 135 of an owner of the user content. Alternatively, the retrieval request may come from a client 130, 135 of a user authorized by the owner to view some or all of the user content.

Account module 212 manages user account information. When using information sharing control, to facilitate various functions, a user can create an account. The account module 212 receives information associated with user accounts from clients 130, 135. User account information may include a user's personal information and a user identifier, and may be maintained in account data store 220, and is one means for performing this function. User account information Account data store 220 can store profile information for registered users. Each user is associated with a unique user identifier, such as a userID, a user name, or a user number. A user's user identifier is assigned by account module 212. Available user identifiers are stored in account data store 220. Alternatively, account module 212 may generate new user identifiers based on previously-assigned user identifiers.

In one embodiment, account information includes account management information, such as account type, e.g., free or paid; usage information for each user, e.g., security settings; personal configuration settings; etc. Account module 212 can be configured to update and/or obtain user account details in account data store 220. An account can be associated with multiple clients 130, 135. Account module 212 can be configured to interact with any number of other modules in controlled communication server 100. Account data store may include characteristics of clients 130,135. Characteristics include hardware model information, network capabilities, operating system information, messaging and notification capabilities and the like.

The request module facilitates connection requests by clients 130, 135 to connect one user account to another In some embodiments, request module 210 receives the connection request and stores it in request data store 224. A connection request includes content handling instructions. Content handling instructions include sharing instructions for which user content to share with the other user, as well as instructions for how the other user may communicate with the first user. Instructions may be stored in request data store 224 or in connection data store 226. Example instructions include instructions to share one or more user content items or data fields with a particular user, instructions to not share one or more user content items or data fields with a particular user, and instructions for how to handle communication from a particular user (i.e. instant messages, short message service (SMS), multimedia message service (MMS), phone calls, emails).

In some embodiments, request module 210 can also generate a connection request message to request authorization of the other user to connect accounts. The connection request message can be sent via SMS or other messaging protocol through message module 200. In some embodiments, message module 200 uses a service number retrieved from service number data store 228 to send the connection request message. In this embodiment, the recipient of the connection request message is able to send a reply message to the service number to accept the connection request.

In various embodiments, if both users are app users, the users initiate a connection via the user interface of the client application, as described in more detail below. In some embodiments, a client application initiates a connection request by using character recognition to read an image containing personal information (e.g., a picture of a business card) or an indication or reference to personal information (e.g., a QR code or other symbolic representation). Example methods for initiating a connection are described in more detail below.

When a connection is made, connection module 208 creates a connection record in connection data store 226. The connection record includes the unique identifiers of the connected users as well as content sharing instructions for both users. The connection record may also include a connection channel retrieved from connection channel data store 230. A connection channel is an address, such as a phone number or SMS short code, that is associated with message module 200. Each connection channel is only associated with one connection for each user. Accordingly when message module 200 receives a message from a user through a particular connection channel, connection module 208 can determine the intended recipient from connection records.

The stored user content can also include content groups of various types with different behaviors, or other user content item grouping methods. A content group includes one or more content items. Content groups may be stored in account data store 220.

A user may create content groups, choose which user content items are associated with each content group, and assign users to a content group. Users assigned to a content group have access to the content items assigned to that content group. For example, an account can include a public user content group that is accessible to any user by default. The public user content group can be assigned a web-accessible address. A link to the web-accessible address can be used to access the contents of the public content group. In another example, an account can include a private user content group that is accessible only to users assigned by the content owner. When a connection is made, the instructions for sharing content may assign zero, one, or more content groups to the connected user, thus giving the connected user access to the content in each such content group.

Message module 200 is configured to facilitate message exchange between users. Message module 200 uses network 110 to send and receive messages. Messages may be sent via a message service or other communication service (e.g., an SMS message service, a native device messaging system, etc.). Examples of a native device messaging system include iOS Push Notifications by APPLE, INC., Cupertino, Calif. and Android Notifications by GOOGLE INC., Mountain View, Calif. Messages may further be sent as internal messages, for example, when the message module of an app client has an active message-data connection with message module 200. An active message-data connection typically exists if the client application of the system is open and displayed on the app client.

Communication event module 202 handles requests to initiate communication events. Communication events include phone calls, phone tags, masked calls, video calls, etc. In some embodiments, communication event module 202 is part of client application 300. Communication event module 202 receives requests to initiate communication events and communicates with various modules of app clients 130 to initiate communication events. Data associated with communication event requests is stored in communication event data store 223.

### Example App Client

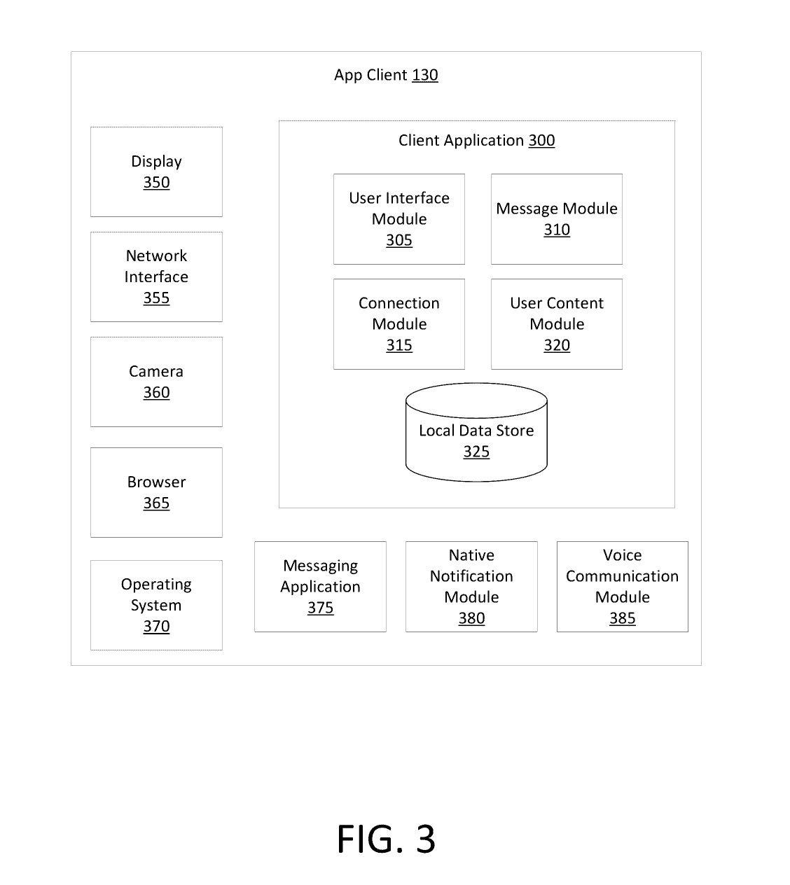

FIG. 3 is an example configuration of app client 130, according to one embodiment. App client 130 includes client application 300, display 350, network interface 355, camera 360, browser 365, operating system 370, and messaging application 375, native notification module 380, and voice communication module 385. In various embodiments, app client 130 may additionally include various components of the example machine of FIG. 1B. Display 350 provides information to a user, and in certain app clients 130 includes a touchscreen. Network interface 355 allows the app client 130 to communicate with controlled communication server 100 as well as with other clients 130, 135 via network 110. In various embodiments, network interface 355 is capable of communication via data networks and/or telecommunications networks (including mobile communication networks). It is noted that the modules described herein may be embodied as instructions stored in a storage device, e.g., 154, 166, and executable by a processor, e.g., 152, so that the processor, e.g., 152, is configured to perform the functions described.

Operating system 370 provides a local file management system and executes the various software modules such as client application 300, messaging application 375, and native notification module 380. Operating system 370 also displays information from applications executing on app client 130 to a user via display 350. Camera 360 may be used to capture images or video for upload.

Native notification modules 380 vary based on the app client, and facilitate delivery of notification messages to the app client user via a native device messaging system. A typical native notification module 380 includes a notification interface that enables client applications 300 and other sources to send notification messages to the app client for display to the user. Notifications may originate on app client 130 or on a server connected to app client 130 via network 110. Messaging application 375 allows the app client user to compose, read, send, and receive messages (e.g., SMS messages, etc.). The messaging application 375 includes a user interface for composing and reading SMS messages, and an SMS interface for transmitting and receiving SMS messages via network 110.

Client application 300 may be a dedicated application or module that provides access to the services of controlled communication server 100, providing user access to user content through a user interface and programmatic access for other applications. App client 130 may also access controlled communication server 100 through browser 365. Client application 300 may take various forms, such as a stand-alone application, an application plug-in, or a browser extension. Client application 300 includes user interface module 305, message module 310, connection module 315, user content module 320, and local data store 325.

User interface module 305 generates an interface to the content accessed by client application 300, as variously illustrated herein, and is one means for performing this function. The generated interface is provided to the user by display 350. Client application 300 may store content accessed from a data store at controlled communication server 100 in local data store 325.

In various embodiments, connection module 315 communicates with various modules of controlled communication server 100 to enable a user to create and manage connections. A user may initiate a connection request, including content sharing instructions, via a user interface element of app client 130. Connection module 315 handles the request and communicates with connection module 208 to create the connection. Connection module 315 may also access existing connections stored on controlled communication server 100 so that a user may view and modify existing connections using app client 130.

User content module 320 manages user content relating to a user's account. In various embodiments, a user can view and modify the user's own user content, content groups, and content sharing instructions via the user interface on device 130. User content module 320 also communicates with user content module 204 to access content items and content sharing instructions associated with a connected user. In some embodiments, user content module 320 is configured to communicate with messaging application 375 and other applications of app client 130. For example, if a connected user has shared a mobile phone number with a user, user content module 320 can communicate with messaging application 375 to open a window to compose an SMS message and automatically populate the recipient's phone number in the appropriate field.

In some embodiments, message module 310 is configured to allow a user of app client 130 to send, receive, compose, and read internal messages. Message module 310 communicates with message module 200 to provide internal messages to a user of app client 130 via the user interface.

User interface module 305 provides a user interface for display and interaction. User interface module 305 also accepts and manages user inputs to the user interface. User inputs are made to various user interface elements via a touchscreen or another user input device, for example, a mouse, trackpad or keyboard. The user interface for information sharing control may be provided to users on display 350 of app client 130.

Voice communication module 385 allows for electronic communication via network 110. In some embodiments, voice communication module 385 allows inter-device audio and/or video communication over a mobile communication network. In other embodiments, voice communication module 385 uses the Internet for inter-device audio and/or video communication. Voice communication module 385 may be, for example, a phone application of a smartphone.

In one embodiment, voice communication module 385 has an associated contact data store, such as a contacts list or application. The contact data store stores contact data on the app client 130. Voice communication module 385 may place calls using the contact data. In one embodiment, client application 300 may direct voice communication module 385 to place a call. This may be in response to a user input or some other action within information sharing control. Voice communication module 385 may also display contact information (e.g., a name) when a call is received from a number stored in the contact data store.

The information sharing control may facilitate masked calling between users. If a first user places a masked call to a second user, the client application 300 of the app client 130 of the first user directs the voice communication module 385 to place a call to a system number associated with communication event module 202. Communication event module 202 receives the call and initiates a second call to a phone number of the second user. The second call is placed via a masked number associated with communication event module 202 and not directly associated with the first user. The two calls are joined, enabling the users to communicate via a voice call. An advantage of masked calling is that there is no direct call from the phone number of the first user to the phone number of the second user, so the first user may place a voice call without sharing a phone number, which would prevent the second user from contacting the first user after the call.

In one embodiment of masked calling, the client application 300 of the second user's app client 130 receives a contact data entry from communication event module 202 prior to receiving the second call. The contact data entry associates the masked number with the first user. Client application 300 may store a name of the first user and the masked number in the contact data store such that voice communication module 385 displays the name of the first user when the masked call is received. In this embodiment, the second user knows that the first user is calling, but is still not provided with the first user's phone number. The second user has a better user experience because he or she knows who is calling, and may make a more informed decision whether to answer the call than if just the masked number was displayed.

### Example Appless Client

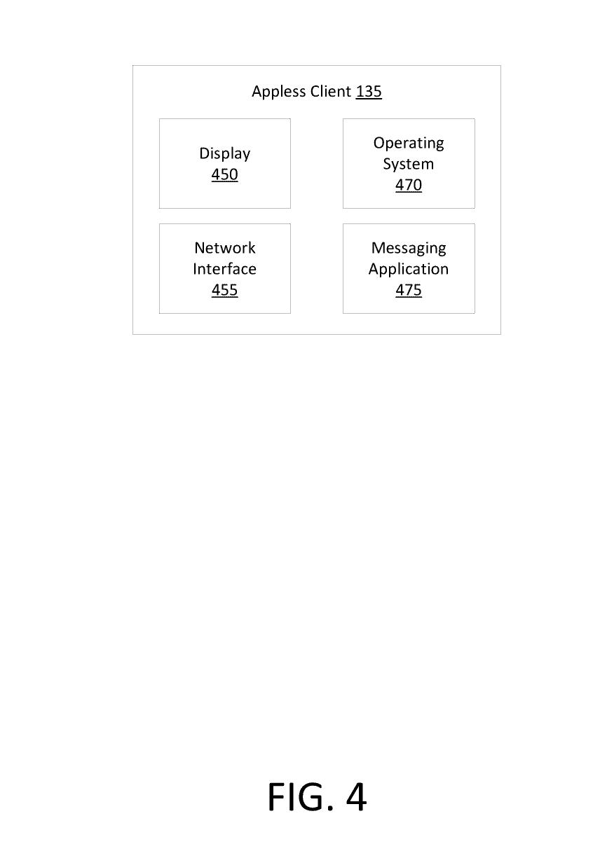

FIG. 4 is an example configuration of an appless client 135, according to one embodiment. Appless client 135 includes display 450, network interface 455, operating system 470, and messaging application 475. In various embodiments, appless client 135 may additionally include various components of the example machine of FIG. 1B. Display 450 provides information to a user, and in certain appless clients 135 includes a touchscreen. Network interface 455 allows the appless client 135 to communicate with controlled communication server 100 as well as with other clients 130, 135 via network 126. In various embodiments, network interface 455 is capable of communication via data networks and/or telecommunications networks (including mobile communication networks).

Operating system 470 provides a local file management system and executes the various software modules such as messaging application 475. Operating system 470 also displays information from applications executing on appless client 135 to a user via display 450. As an example of one communication channel, messaging application 475 allows the appless client user to compose, read, send, and receive SMS messages SMS application includes a user interface for composing and reading SMS messages, and an SMS interface for transmitting and receiving SMS messages via network 110.

### Example Connection Initiation Process

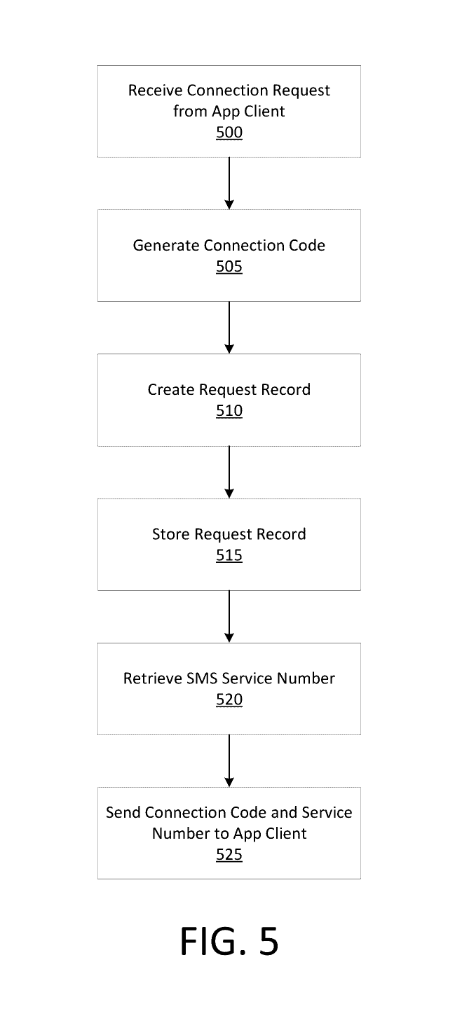

FIG. 5 illustrates an example process for initiating a connection between app user 140 of the app client 130 and an appless user 145 of the appless client 135 in a controlled communication server. The controlled communication server 100 receives 500 a connection request from an app client 130. The connection request may include a reference to one or more user content items that the user 140 of the app client 130 wishes to share with another user. In various embodiments, the connection request is received by request module 210. Request module 210 generates 505 a connection code responsive to the request. The connection code is a unique code associated with the two users seeking connection. The request module creates 510 a request record. The request record includes the generated connection code as well as the unique identifier of the app user 140 of the app client 130. The request record is stored 515 in request record data store 224.

Request module 210 retrieves 520 a service number from service number data store 228. Request module 210 then sends 525 the connection code and the service number to the app client 130 for display to the app user 140. The app user 140 can share the connection code and service number to an appless user 145 of an appless client 135. Sharing may happen in person (e.g., visually or audibly), or via some other form of communication, as represented by the dashed line between users in FIG. 1A. For example, the appless user 145 may use SMS application 475 of appless client 135 to send the connection code to the service number.

### Example Communication Channel Creation Process

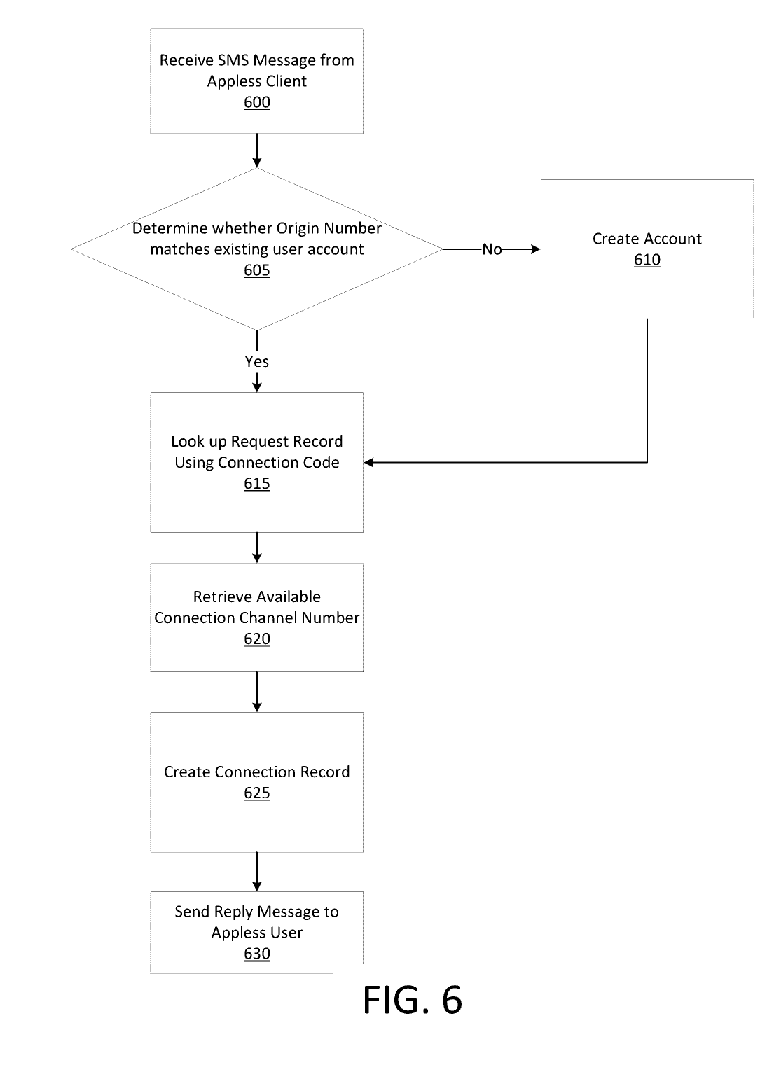

FIG. 6 illustrates an example process for creating a communication channel between users of information sharing control. In one embodiment, message module 200 of controlled communication server 100 receives 600 an SMS message from an appless client 135. The SMS message includes the origin number (a 10-digit phone number or other SMS identifier), the destination number, and a previously-sent connection code as the SMS message content. Account module 212 determines 605 whether the origin number matches an existing user account stored in account data store 220. If the origin number does match an existing user account, the process proceeds to step 615 as indicated in FIG. 6. If the origin number does not match an existing user account, account module 212 creates 210 a new account record in account data store 220. The account record contains a newly-assigned unique user identifier as well as the origin number. Connection module 208 looks up 615 the request record associated with the connection code in request record data store 224. Connection module 208 retrieves 620 an available connection channel number from connection channel data store 230. In one embodiment, an available connection channel number may be in use by other users, but it is not in use by the appless user. In this embodiment, a combination of the appless user's unique user identifier and the connection channel number is unique and may be specifically associated with a connection record associated with the appless user and the app user described above. Connection module 208 creates 625 the connection record in connection data store 226. The connection record includes the connection channel number, the user identifier of the user who initiated the request from the request record, and the user identifier of the appless user. Message module 200 sends a reply message to the appless user (via the origin number). The reply message may include shared user content of the requesting user.

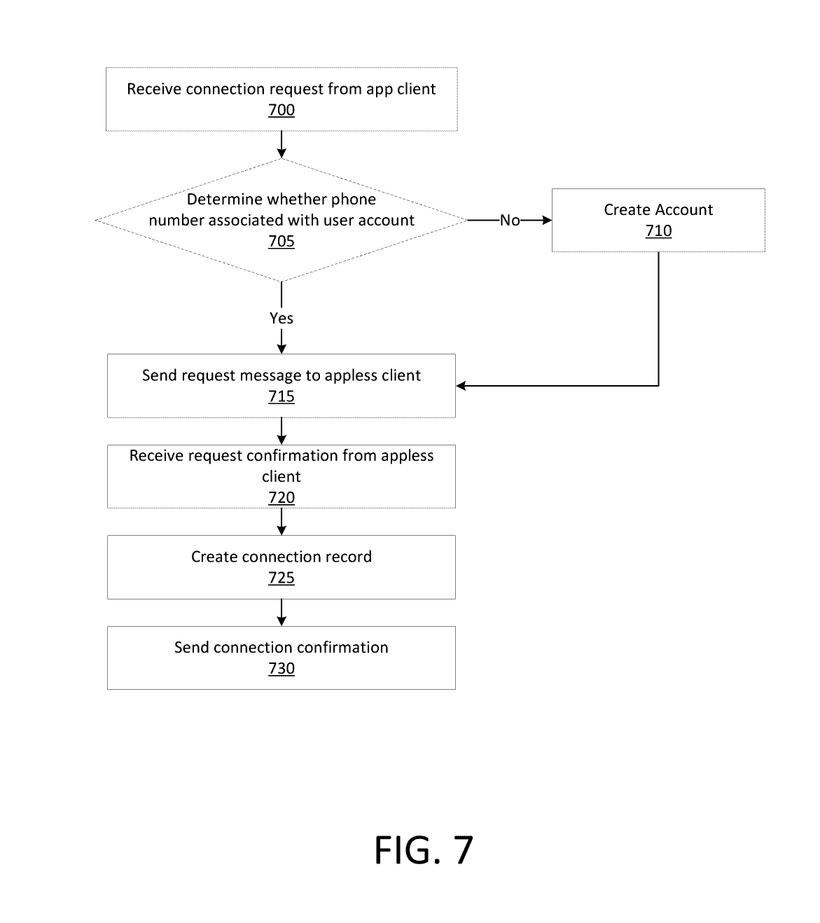

FIG. 7 illustrates an example process for connecting an app user with an appless user. Request module 210 receives 700 a connection request from an app client 130. The connection request may include an identifier of the appless user. The identifier may be a phone number or a user identifier. If the identifier is a phone number, the request module 210 will determine 705 from account data store 220 whether the phone number is associated with a user account of the information sharing control. If the phone number is not associated with a user account, account module 212 creates 710 a user account and associates a user identifier with the phone number in account data store 220. The example process then proceeds to step 715. If the phone number is associated with a user account, the example process proceeds directly to step 715. Connection module 208 sends 715 a request message to the appless client 135. The request message gives the appless user the ability to accept or reject the connection request, for example by transmitting different text strings as a reply message. If the appless user rejects the connection request, the process ends. In one embodiment, a record of the rejection is stored in request data store 224, and further attempts by the app user to send a connection request to the appless user will not be processed by the controlled communication server 100. If the appless user accepts the connection request, connection module 208 receives 720 a request confirmation from the appless client. Connection module 208 creates 725 a connection record in connection data store 226. The connection record may include the user identifier of the app user and the user identifier of the appless user. In one embodiment, the connection record further includes content sharing instructions, including one or more content groups assigned to the appless user by the app user. Message module 200 sends 730 a connection confirmation to the appless client 135. In one embodiment, the connection confirmation is sent from a connection channel retrieved from connection channel data store 230. The connection channel is stored with the connection record such that a message from the phone number to the connection channel uniquely corresponds to the connection between the appless user and the app user. This allows message module 200 to properly route messages from the appless user to the app user.

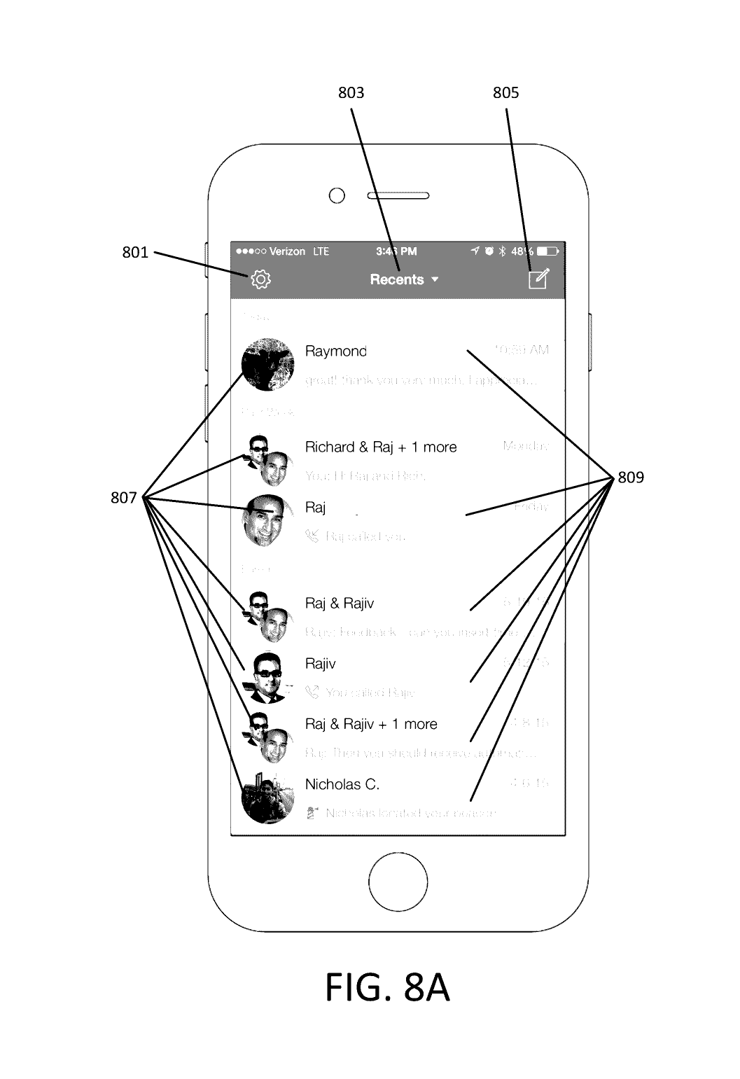

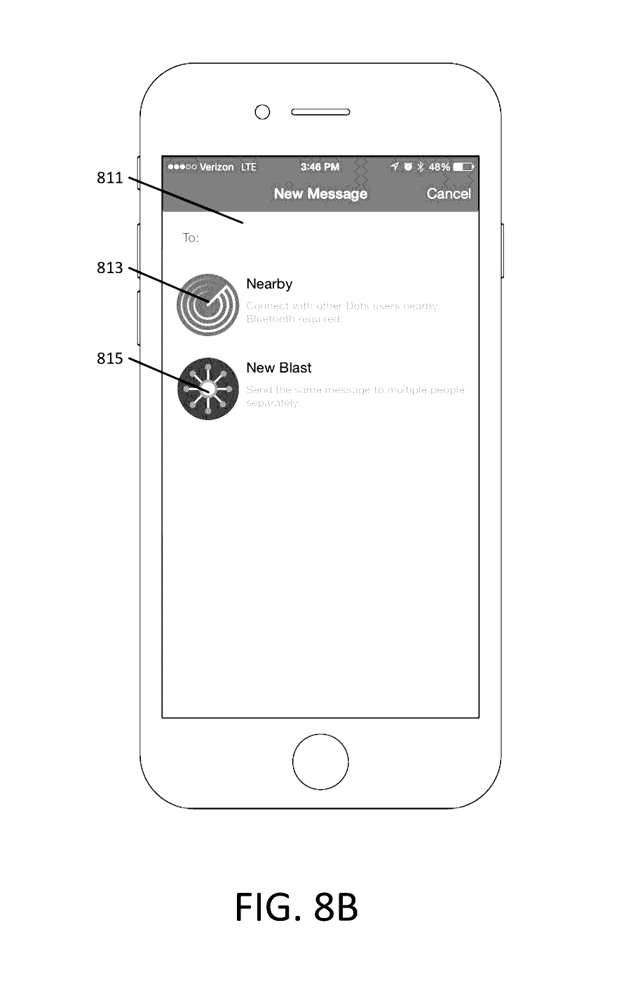

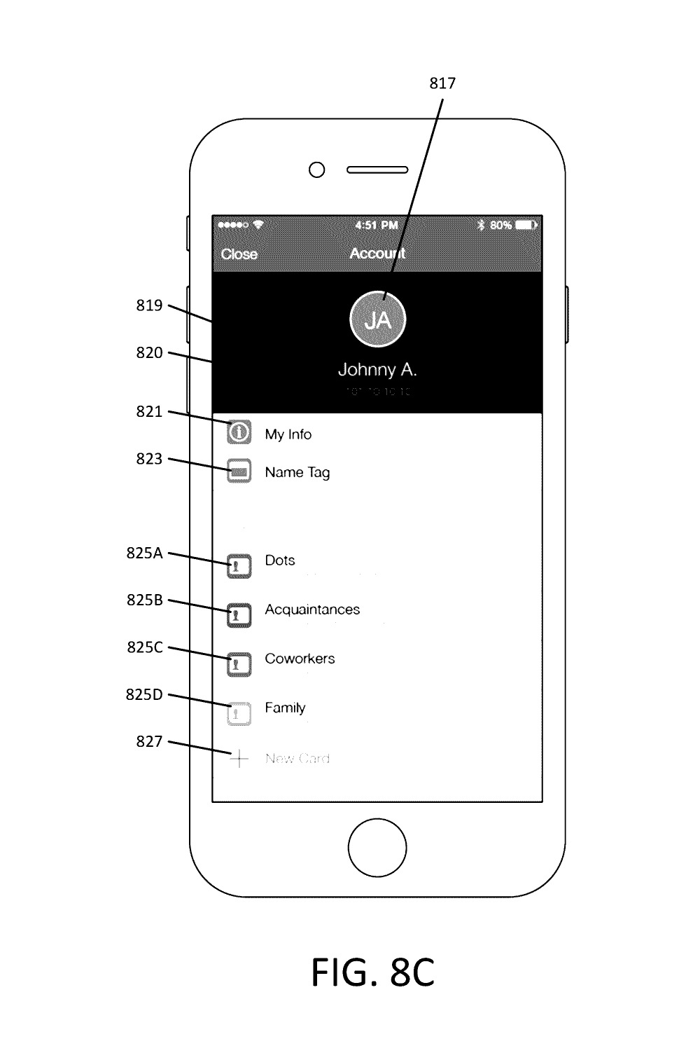

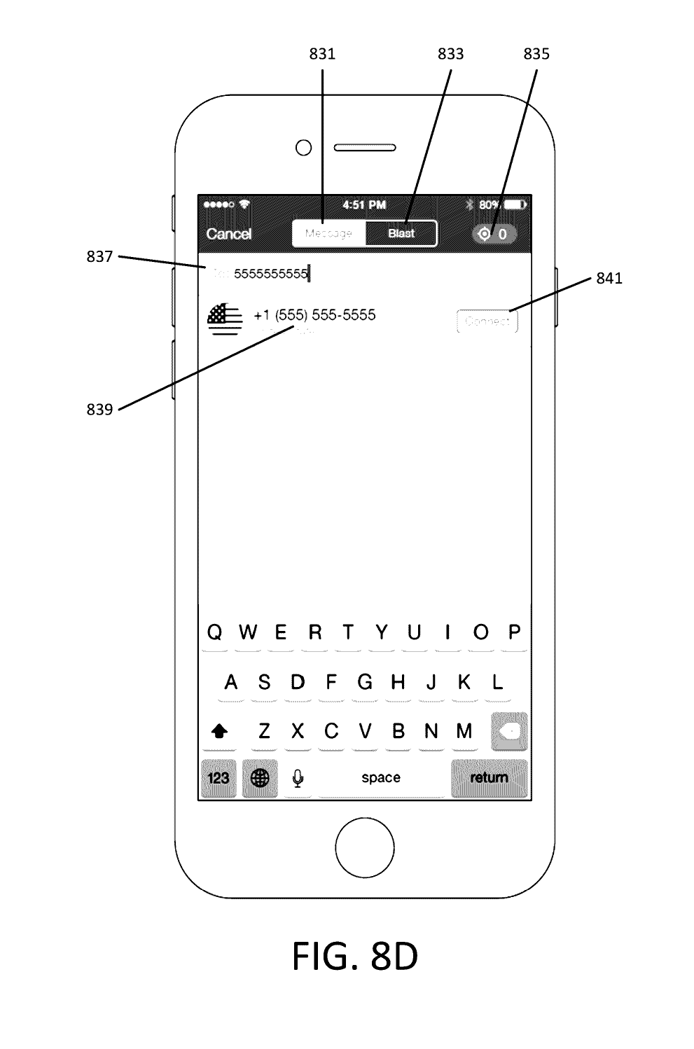

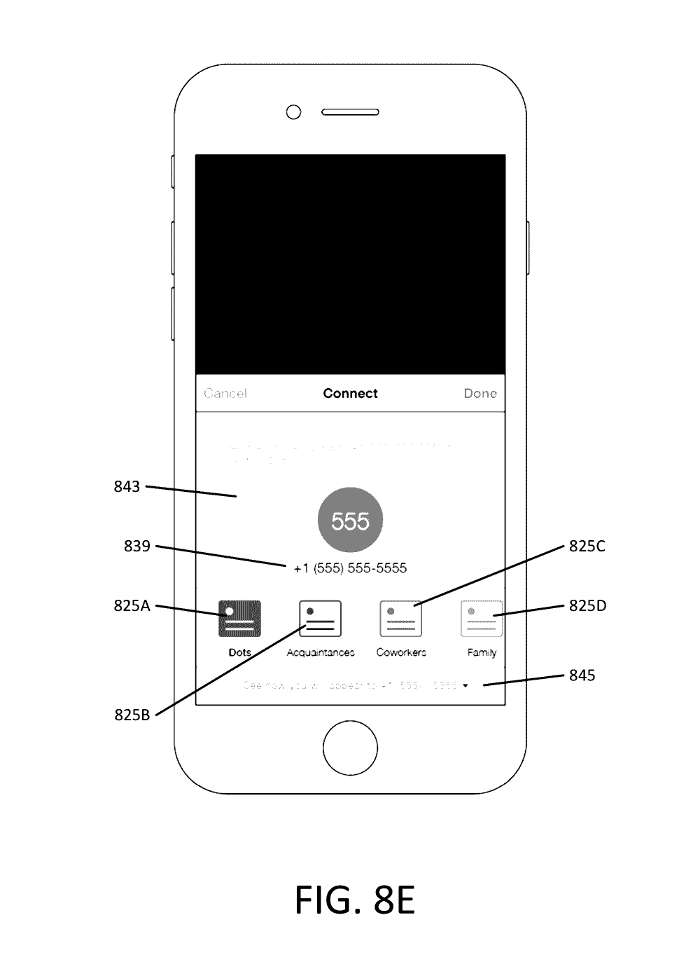

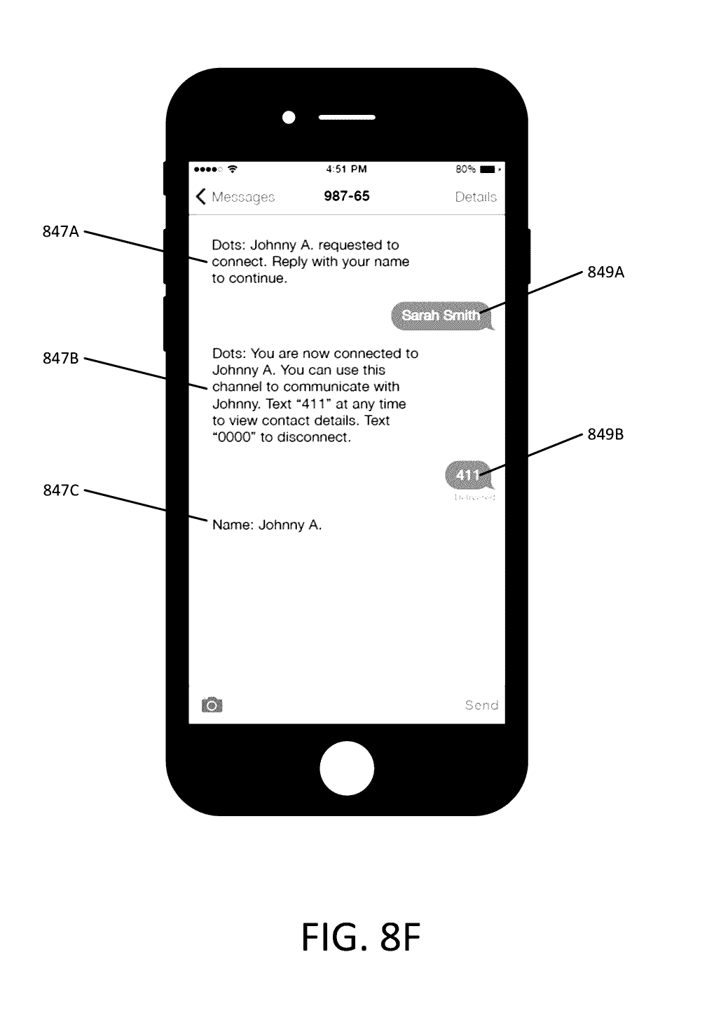

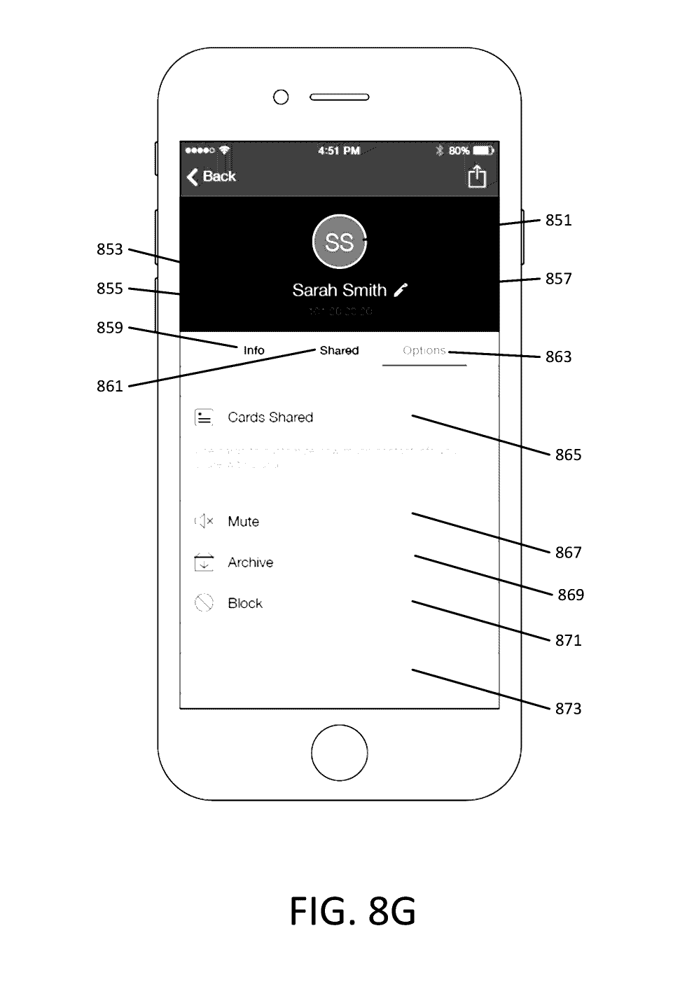

FIGS. 8A-8C show example user interfaces for information sharing control. The example user interface of FIG. 8A illustrates various user interface (UI) elements that a viewing user can use to interact with information sharing control. UI elements 809 display information about users with which the viewing user is connected. In one embodiment, UI elements 809 may display information about a user with which the viewing user has communicated with but is not connected. For example, UI elements 809 may display a name of a connected user, as well as recent communication events associated with the connected user and the viewing user. Communication events may include exchanged messages, voice calls, video calls, phone tags, and connection requests. Communication events may have occurred outside the information sharing control, for example, via another application of the client 130, 135. For example, the viewing user may participate in a voice call with a connected user using the voice communication module 385 of the app client 130 of the viewing user. Client application 300 may detect that the voice call occurred and send a record of the voice call to communication event module 202 for storage in communication even data store 223.

UI elements 809 may include a date associated with a communication event, for example, the most recent communication event. UI elements 809 may further include a profile picture 807 of the connected user.

Filter element 803 allows a viewing user to change which connected users are displayed in the list of communication event information. Communication element 805 allows a viewing user to initiate communication events with connected users and other users, as described in more detail with respect to FIG. 8B. Account access element 801 allows the viewing user to access a user interface for viewing and editing content items and content groups, as described in more detail with respect to FIG. 8C.

FIG. 8B shows an example user interface for initiating a connection or communication event using information sharing control. Recipient element 811 allows the viewing user to enter identifying information (e.g., a name, phone number, user identifier, etc.) associated with connected users or other users. When a user enters identifying information into recipient element 811, a list of matching users may be displayed which allow the user to access shared content items and initiate communication events. Proximity connection element 813 allows a viewing user to connect with nearby users using a wireless communication protocol, such as BLUETOOTH. One-to-many element 815 allows a user to send a message to multiple users simultaneously. In one embodiment, each particular receiving user sees the message as a one-to-one message sent from the viewing user to the particular receiving user. This allows a viewing user to initiate one-to-one communication with more than one receiving user without having to compose and send the message multiple times.

FIG. 8C shows an example user interface for viewing and editing content items and content groups. UI elements 817, 819, and 820 constitute a name tag, which comprises content items that are shared by default with all users of information sharing control. The viewing user may adjust which content items are included in the name tag using the name tag element 823. Content item element 821 allows a viewing user to access, for viewing and editing, a list of all content items associated with the user's account.

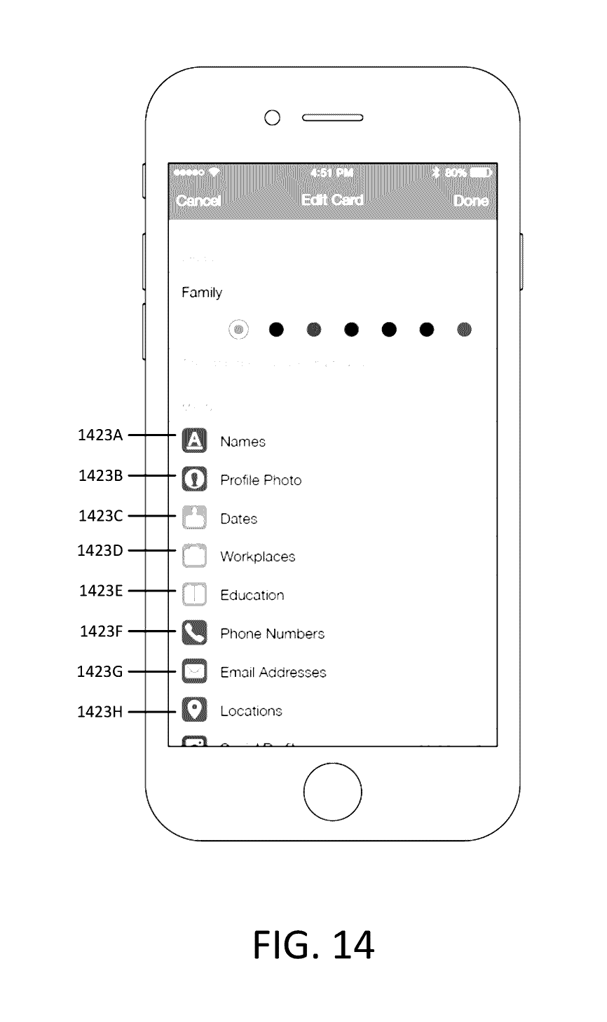

Content group elements 825A-D allows a viewing user to access a user interface for viewing and editing content group information. Content group information may include a list of which content items are shared with the content group, a list of members of the content group. An example user interface for viewing and editing content group information is described in more detail with respect to FIGS. 14A-B. Content group elements 825A-D may display a number of members of the corresponding content group. New group element 827 allows the viewing user to create a new content group.

FIG. 8D shows an example user interface for initiating a connection or transmitting a message. A user may initiate a connection with an unconnected user or send a message to a connected user by entering a phone number, user identifier, or other content item in element 811. UI element 839 returns information regarding the entered information. For example, in this example, the entered number has been identified as a phone number from the United States. A viewing user may select UI element 839 to display a user interface that allows the viewing user to compose and send a message to the number. UI elements 831 and 833 allow the viewing user to select whether the message is a one-to-one message or multiple one-to-one messages, similar to element 815 of FIG. 8B. If the number is not associated with a user that is connected to the viewing user, UI element 841 allows the viewing user to send a connection request to the phone number, as described in more detail with respect to FIG. 8E. UI element 835 displays a number of users that are nearby and available for a connection as indicated by a wireless communication protocol such as BLUETOOTH.

FIG. 8E shows an example user interface for transmitting (or sending) a connection request. A connection request may be initiated, for example, by selecting UI element 841 of FIG. 8D. Content group elements 825A-D allows a viewing user to select one or more content groups to assign to the connecting user when a connection is established. UI element 845 allows the viewing user to view which content items will be shared with the connecting user when a connection is established.

FIG. 8F illustrates an example SMS message thread for a connection request received on an appless client 135. Received messages 847A-C are received from controlled communication server 100. Sent messages 849A-B are sent by the appless client 135. Message 847A is sent when an app user 130 initiates a connection request. The appless user may send reply message 849A to initiate a connection. Message 847B confirms that a connection has been established. Message 847B also indicates procedures for disconnection (“Text ‘0000’ . . . ”) and viewing content items shared by the app user (“Text ‘411’ . . . ”). The appless user may send reply message 849B, which in this example is a request to view content items shared by the app user 130. Connection module 208 receives the request and sends a message 847C to the appless client with the content items shared with the appless user.

FIG. 8G shows an example user interface for managing a connection with a connected user. UI elements 851, 853, and 855 display content items associated with the connected user, and may include a picture, a name, and a user identifier. UI element 857 allows the user to edit the display name of the connected user. UI element 865 displays a number of content groups to which the connected user has been assigned. The user of the app client 130 may select UI element 865 to view and edit a list of content groups to which the user has been assigned. Mute element 867 allows the app user to mute communications from the connected user. Muting communications may include not displaying notifications for received communications, not making sounds for notifications, etc. Archive element 869 allows the app user to archive messages for later viewing. Block element 871 allows the app user to block the connected user. Blocking the connected user may include ending sharing of content items, not delivering messages, not allowing communication events between the app user and the connected user, etc. Clear history element 871 allows the app user to delete saved communication events associated with the connected user. In one embodiment, saved communication events are deleted from the app client 130 only. In another embodiment, saved communication events are deleted from controlled communication server 100.

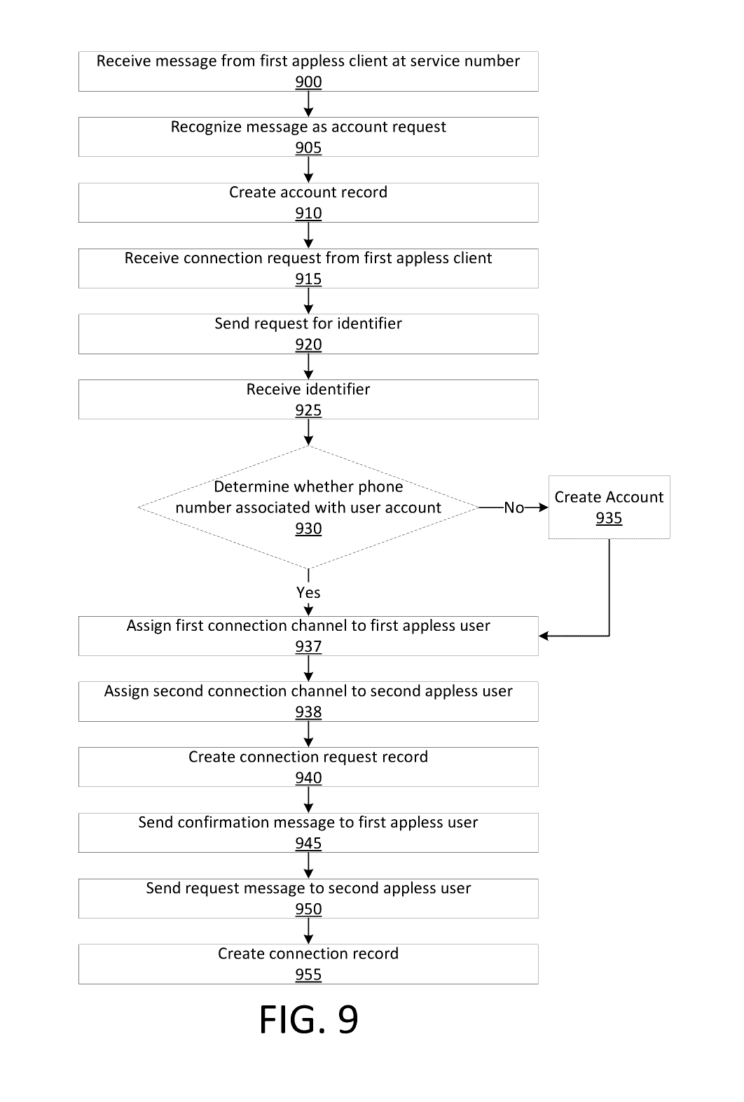

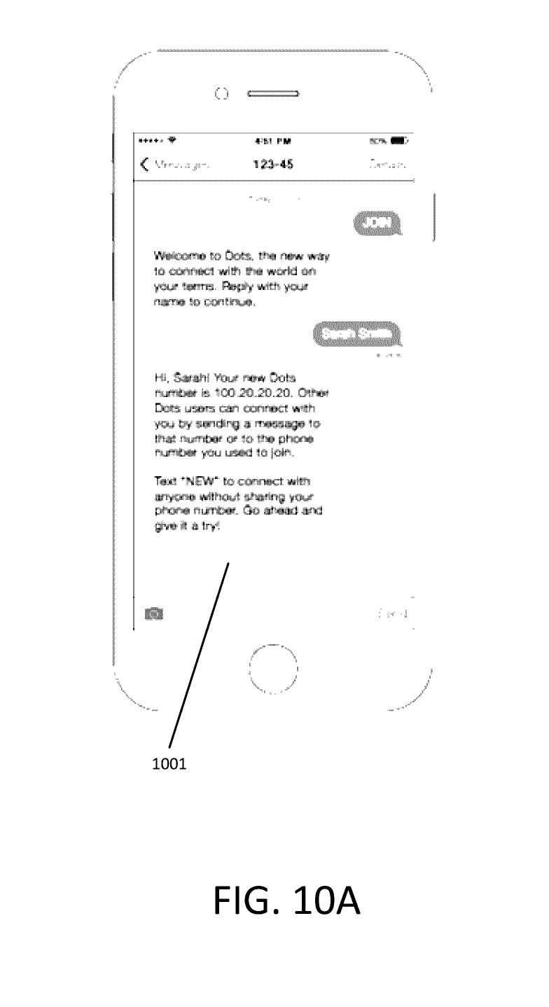

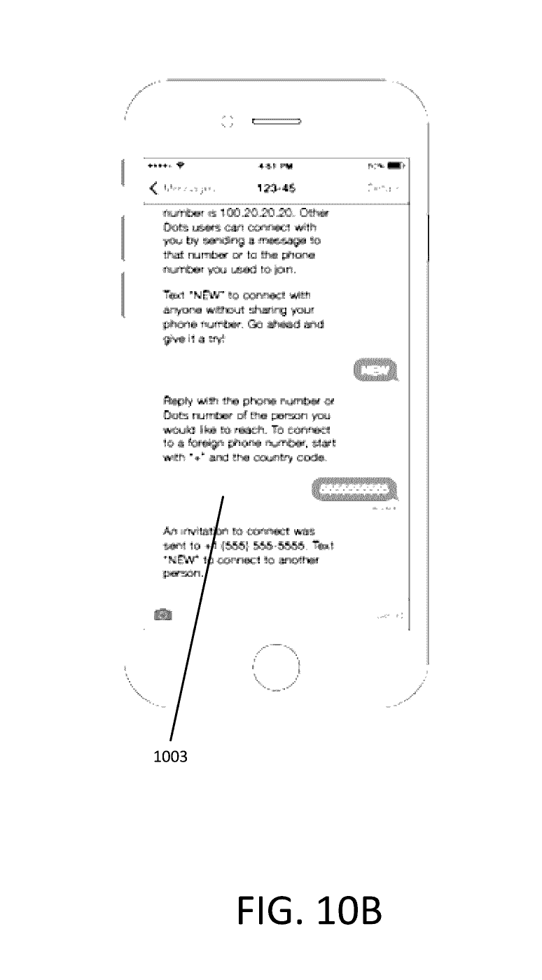

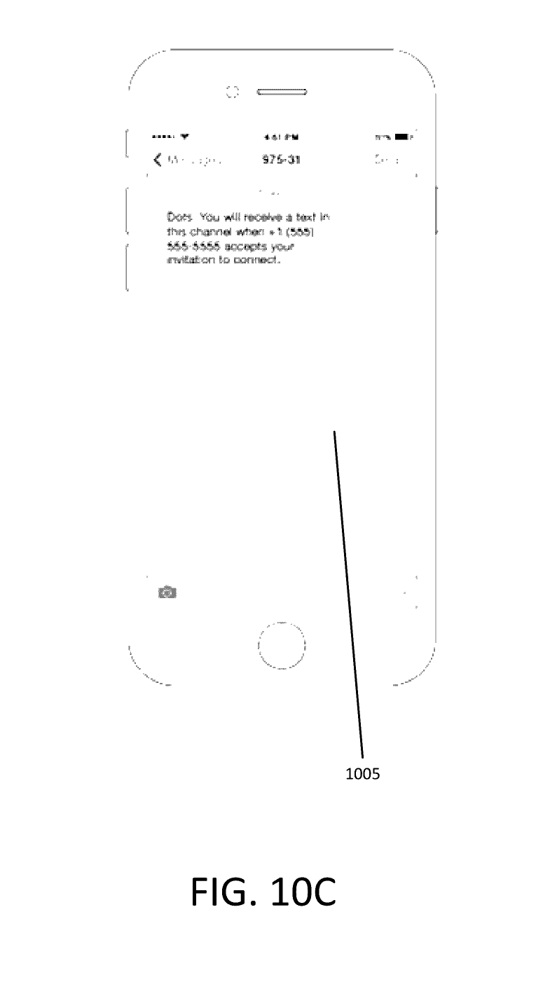

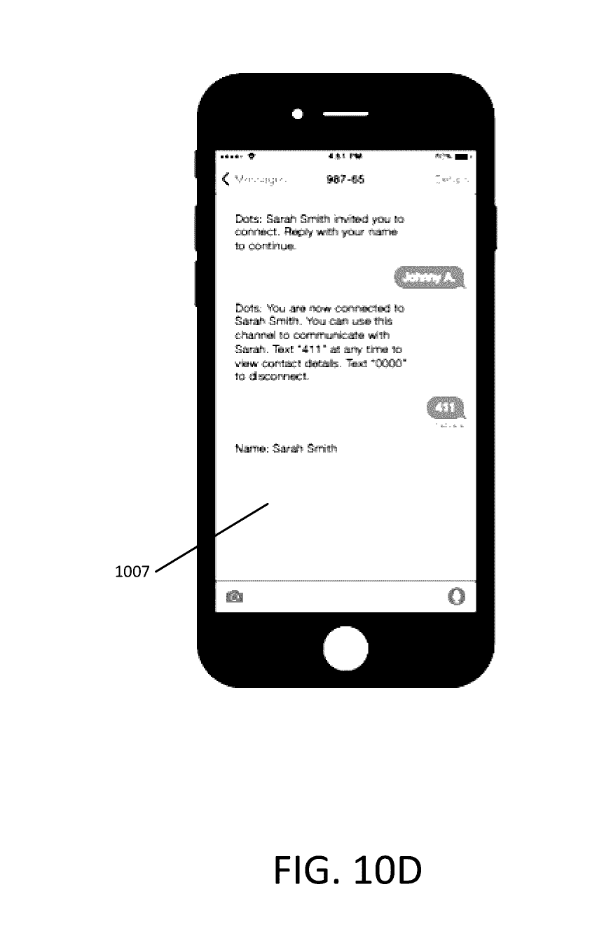

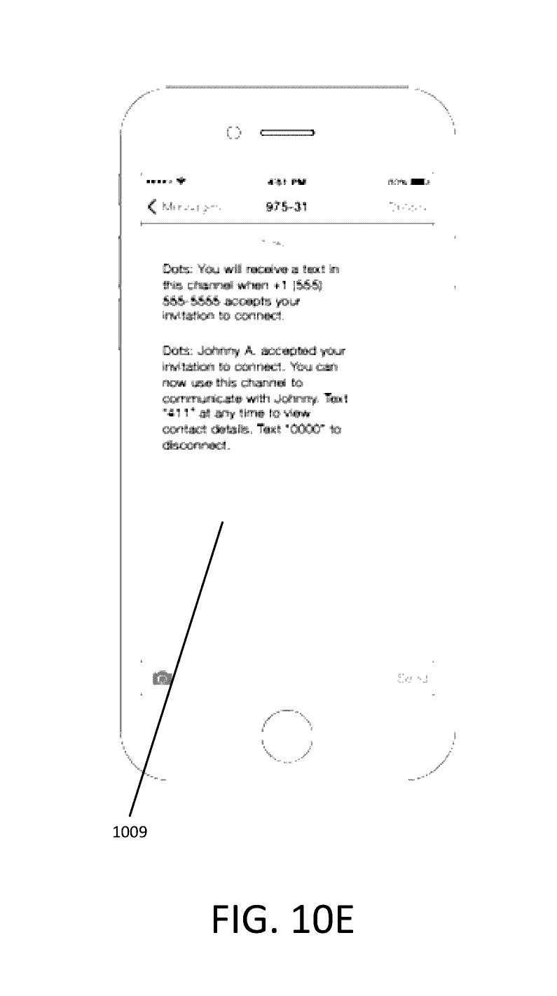

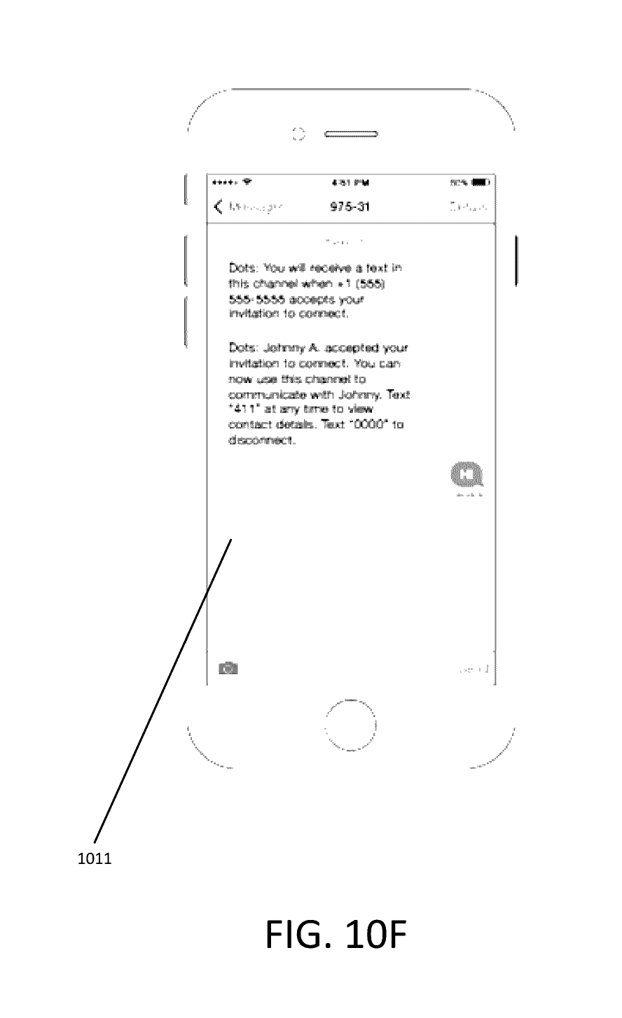

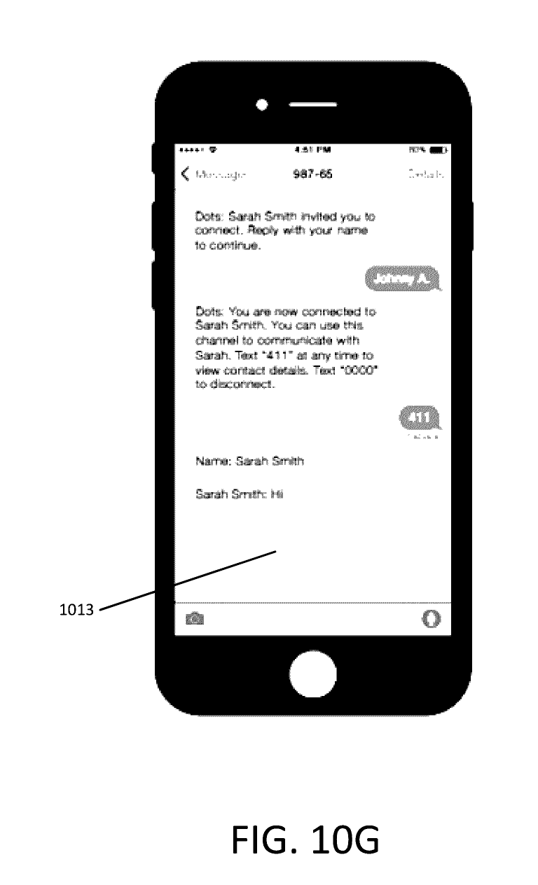

FIG. 9 illustrates an example process for creating an account and connecting a first appless user with a second appless user. FIGS. 10A-G show example messages relating to the process of FIG. 9. Message module 200 receives 900 a message comprising an account request from a first appless client 135. The account request may be a specific text string (e.g. “JOIN”) sent to a particular service number, such as a phone number or SMS short code (e.g., “123-45”), as shown in message screen 1001 of FIG. 10A. Account module 212 recognizes 905 the message as a request to create an account. Account module 212 creates 910 an account record in account data store 220. The account record includes a user identifier and the phone number from which the account request was received. Message module 200 may send a message requesting more information (e.g., a name of the first appless user), as shown in message screen 1001. Additional information received may be stored in account data store 220. Message module 200 may further send the user identifier assigned to the first user and instructions for connecting with other users of information sharing control.

Message module 200 receives 915 a connection request from the first appless client 135 to connect with a second appless user. The connection request may be a specific text string (e.g., “NEW”) sent to the service number, as shown in message screen 1003 of FIG. 10B. Message module 200 may send 920 a request for an identifier (e.g., a phone number or user identifier of the appless user). Message module 200 receives 925 the identifier. If the identifier is a user identifier, the process proceeds directly to step 937. If the identifier is a phone number, connection module 208 determines 930 whether the phone number is associated with a user identifier in user content data store 222. If the phone number is associated with a user identifier, the process proceeds to step 940. If the phone number is not associated with a user identifier, account module 212 creates 935 an account, which comprises assigning a user identifier and creating an account record in account data store 220 that associates the phone number with the user identifier. Connection module 208 assigns 937 a first connection channel to the first appless user. Connection module 208 assigns 938 a second communication channel to the second appless user. Connection module 208 creates 940 a connection request record that associates the user identifier of the first appless user with the user identifier of the second appless user and is stored in connection data store 226. The connection record may further include the first connection channel and the second connection channel.

Message module 200 sends 945 a confirmation message to the first appless user indicating that the request has been sent. The confirmation message sent to the first appless user may be sent from the service number, the first connection channel, or both, as illustrated in message screen 1003 of FIG. 10B and message screen 1005 of FIG. 10C. The message module 200 sends 950, from the second connection channel, a request message to the second appless client 135 inviting the second appless user to connect to the first appless user, as illustrated in message screen 1007 of FIG. 10D. If the second appless user does not reply, the process does not proceed. If the second appless user replies, for example with a name as illustrated in message screen 1007, connection module 208 converts 955 creates a connection record, for example by converting the connection request record into a connection record, which allows communication between the appless users via information sharing control. Once the connection has been established, message module 200 may send a confirmation message to the first and second appless users, as illustrated in message screen 1007 of FIG. 10D and message screen 1009 of FIG. 10E. In one embodiment, confirmation messages include instructions for how to disconnect (e.g., text ‘0000’) as illustrated in message screens 1007 and 1009. In another embodiment, confirmation messages include instructions for viewing content items associated with the connected user (e.g., text ‘411’) as illustrated in message screens 1007 and 1009. The content items shared by connected users may be a set of default content items, which may be chosen and edited by the sharing user. In one embodiment, content items associated with appless users may be edited via a message interface that uses text commands similar to the message interface of FIGS. 10A-10G. In another embodiment, content items may be edited via a web interface.

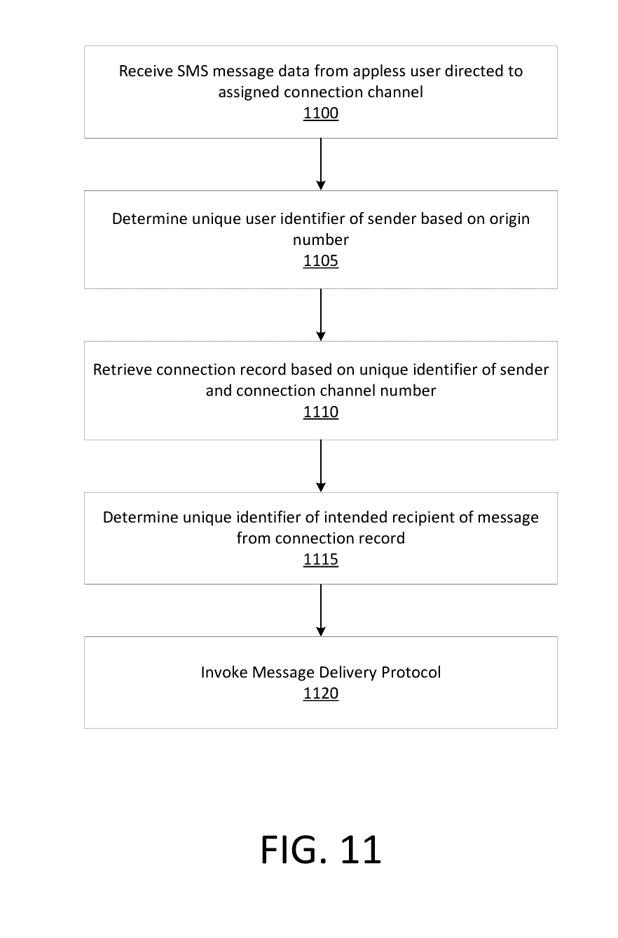

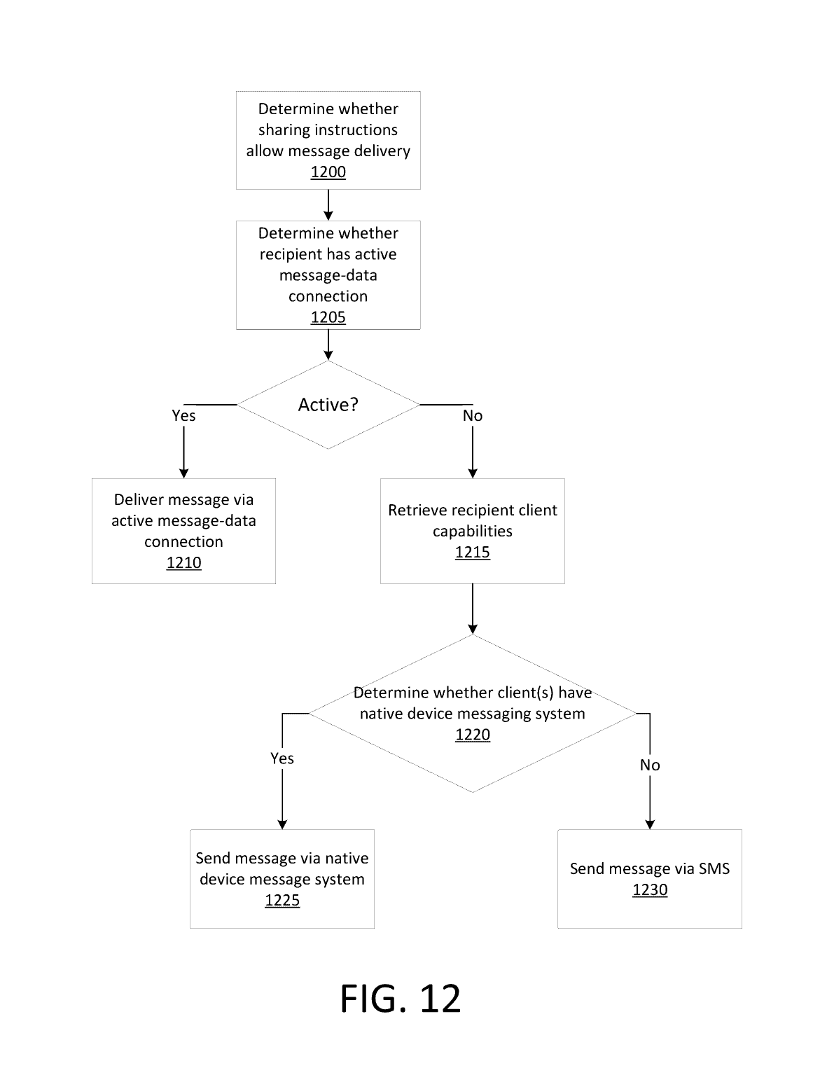

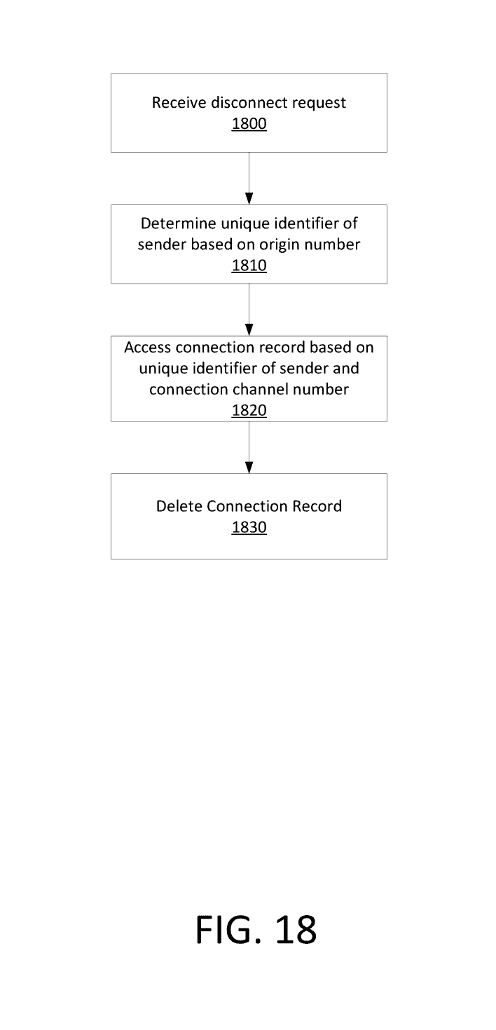

Based on the connection record, messages received by message module 200 at the first connection channel from a number associated with the first appless user can be uniquely identified by message module 200 as being sent by the first appless user with the second appless user as the intended recipient. Similarly, messages received by message module 200 at the second connection channel from a number associated with the second appless user can be uniquely identified as being sent by the second appless user with the first appless user as the intended recipient. In this way, controlled communication server 100 may facilitate controlled communication between the first appless user and the second appless user, as illustrated in message screen 1011 of FIG. 10F and message screen 1013 of FIG. 10G. Message routing is discussed in more detail with respect to FIGS. 11 and 12. As long as the connection record is valid, message module 200 may pass messages between the first appless user and the second appless user. If the connection record is disconnected by either party, connection module 208 may remove the association between the communication channels and the users, and message module 200 will cease relaying messages. Disconnection is discussed in more detail with respect to FIG. 18.

### Example Message Routing

FIG. 11 illustrates an example process for routing messages with information sharing control. In various embodiments, message module 200 receives 1100 an SMS message from an appless user 135. The SMS message is sent to a connection channel number and has an associated origin number and a message. Connection module 208 determines 1105 the user identifier of the sender of the message from the sender's account record in account data store 220. Connection module 208 retrieves 1110, from connection data store 226, the connection record that is uniquely associated with the appless user and the connection channel number. From the connection record, connection module 208 determines 1115 the unique user identifier of the intended recipient of the message. Connection module 208 invokes 1120 the message delivery protocol, as described in FIG. 12.

FIG. 12 illustrates an example process for delivering messages to users of information sharing control. The process of FIG. 12 may be initiated as part of the process in FIG. 11 or it may be initiated in another situation in which a sending user sends a message to a receiving user. Connection module 208 determines 1200, from the connection record, whether the content sharing instructions allow delivery of the message from the sending user to the receiving user. In one embodiment, if sharing instructions do not allow delivery, the sending user is notified. If sharing instructions do allow delivery, connection module 208 determines 1205 whether the client of the recipient has an active message-data connection. If the client of the recipient has an active message-data connection, the message is delivered 1210 by message module 200 via the active message-data connection. If the client of the recipient does not have an active message-data connection, connection module 208 retrieves 1215 client characteristics of the receiving user in account data store 220. Specifically, connection module 208 determines 1220 whether clients 130, 135 associated with the receiving user have a native device messaging system that is accessible by message module 200. If one or more clients 130, 135 associated with the receiving user have a native device messaging system that is accessible by message module 200, message module 200 sends 1225 the message via the native device message system. If one or more clients 130, 135 associated with the receiving user do not have a native device messaging system that is accessible by message module 200, message module 200 sends 1230 the message via SMS.

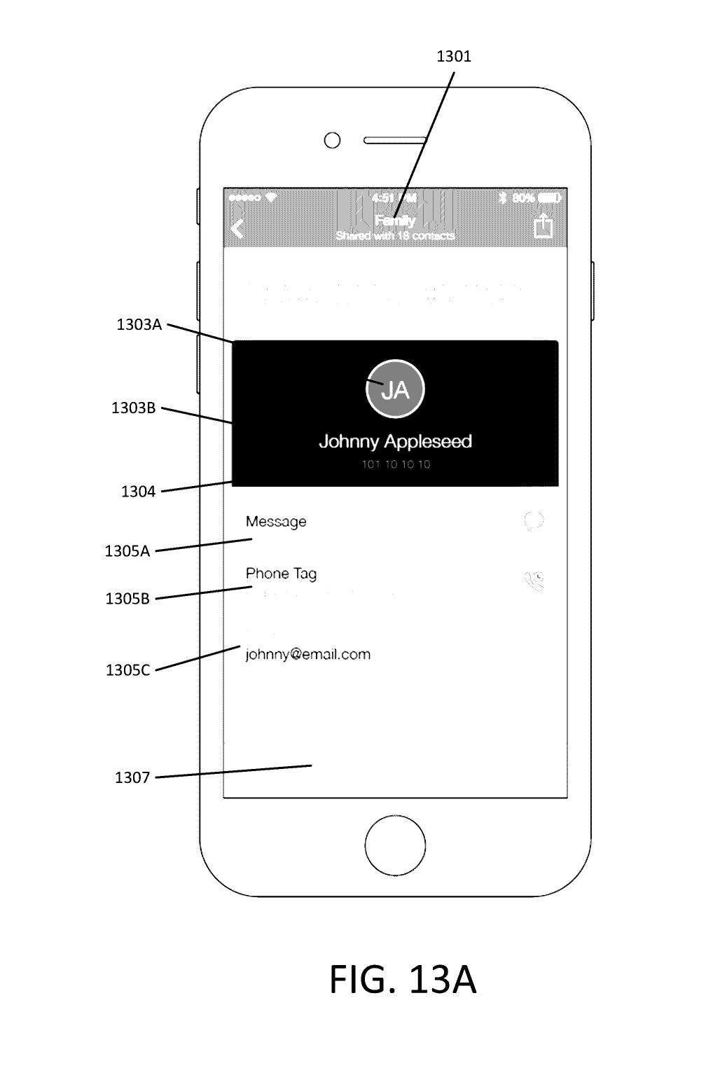

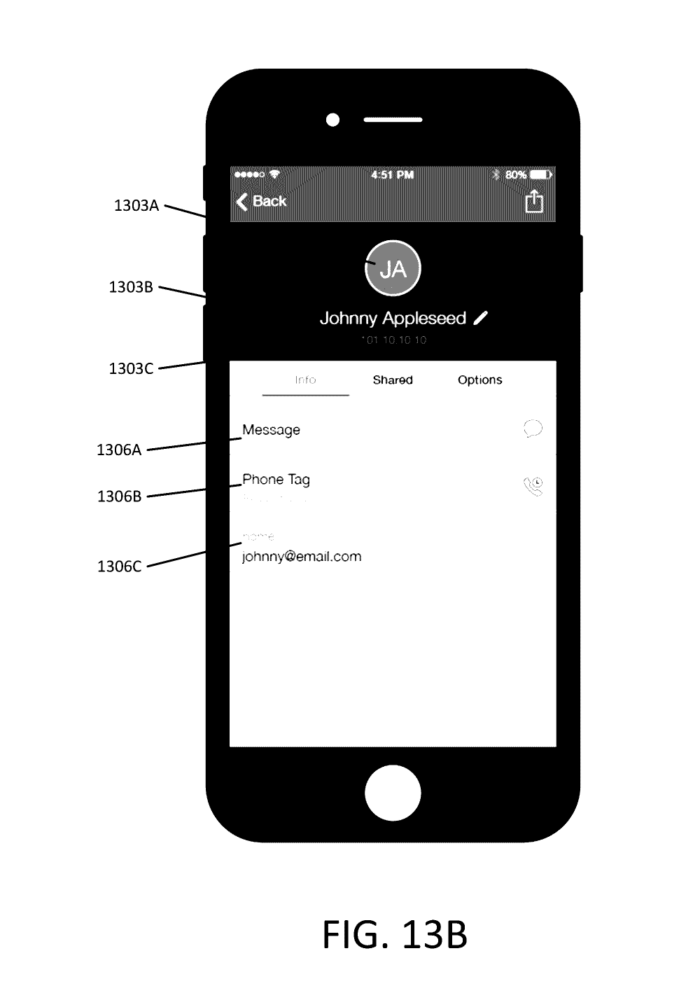

FIG. 13A shows an example user interface displaying a first app user's own content items shared with a first content group. The example user interface of FIG. 13A displays a content item card corresponding to a content group. The content item card displays the content items shared with users assigned to the content group. The example user interface of FIG. 13A can be accessed, for example, by selecting content group element 825D of the example user interface of FIG. 8C or by selecting element 865 of FIG. 8G. UI element 1301 displays a name of the content group and the number of users assigned to the content group. UI elements 1303 A and B display a photo and a name of the first app user that users assigned to the content group will see. UI element 1304 displays the user identifier of the first app user. UI elements 1305A-C display options for initiating communication events and other content items that users assigned to the content group are able to view. Edit element 1307 allows a user to edit the displayed content items and communication events.

FIG. 13B shows an example user interface for displaying a first app user's content items on an app client of a second app user that is assigned to a content group. The content item card from FIG. 13A is visible on the app client of the second app user. The second app user may select UI elements 1306A-C to initiate communication events with the first app user.

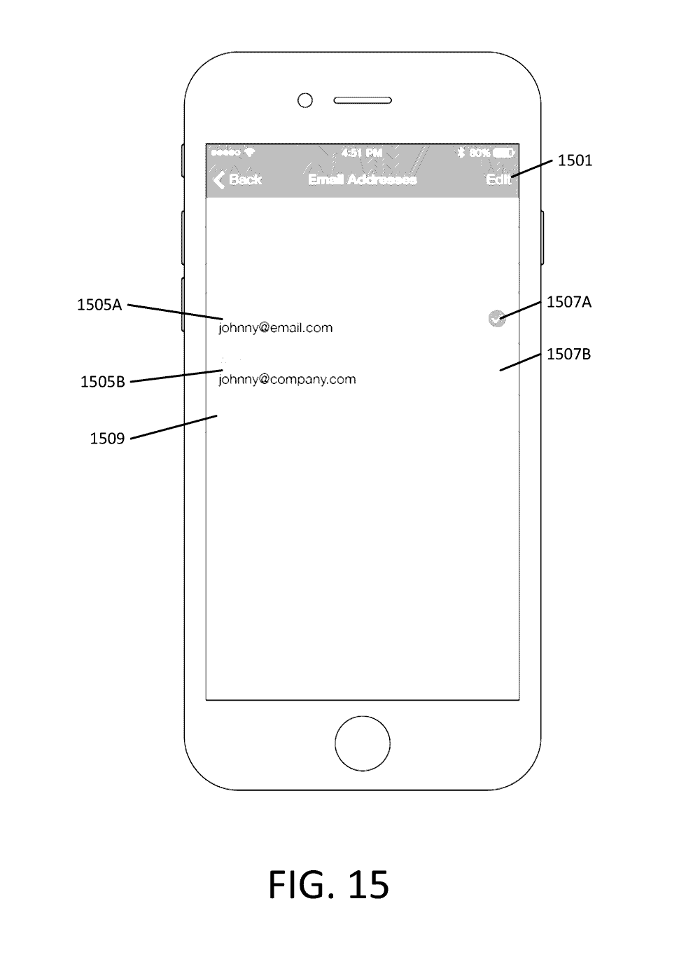

FIG. 14 shows an example user interface for editing the content items associated with a content group. The first app user may edit the content group by changing the name, selecting a color associated with the content group, editing which content items are shared with members of the content group, and editing the content items themselves. UI elements 1423A-H display various types of content items, as well as how many are shared with members of the content group. A user may select the UI elements 1423A-H to edit content items and choose which content items are shared, which is described in more detail with respect to FIG. 15.

FIG. 15 shows an example user interface for viewing and editing content items and selecting which content items are shared with a content group. A user may access the user interface of FIG. 15A, for example, by selecting UI element 1423G of the user interface of FIG. 14. UI element 1501 allows a user to edit displayed content items 1505A-B. UI element 1509 allows a user to add a new content item. UI elements 1507A-B allow a user view and edit which content items are shared with the content group.

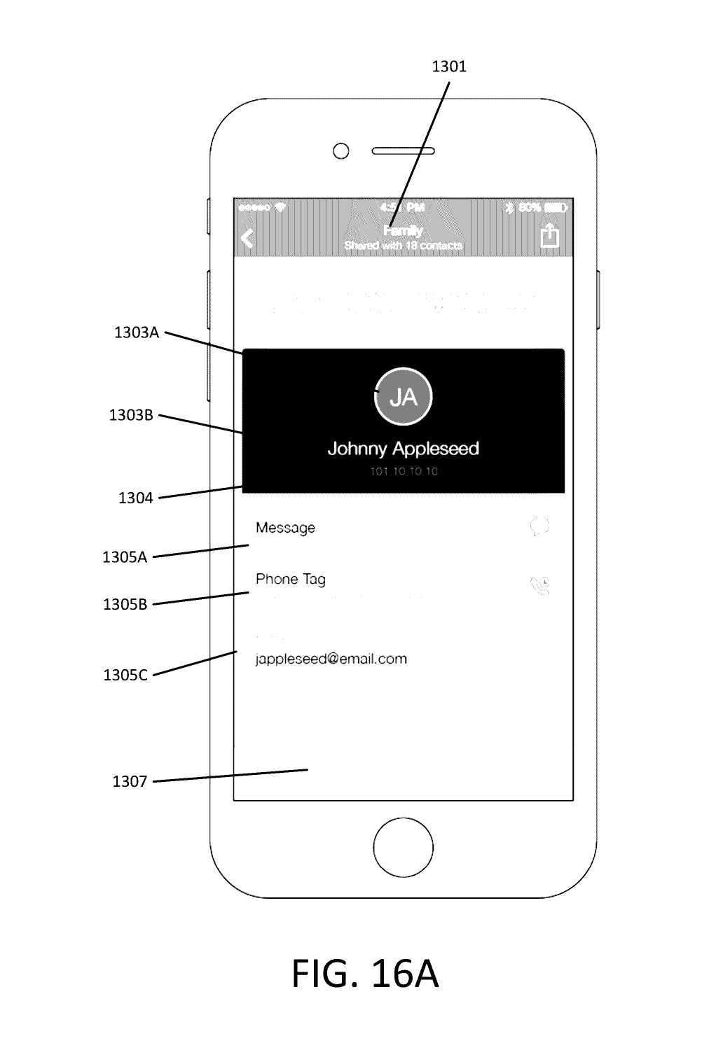

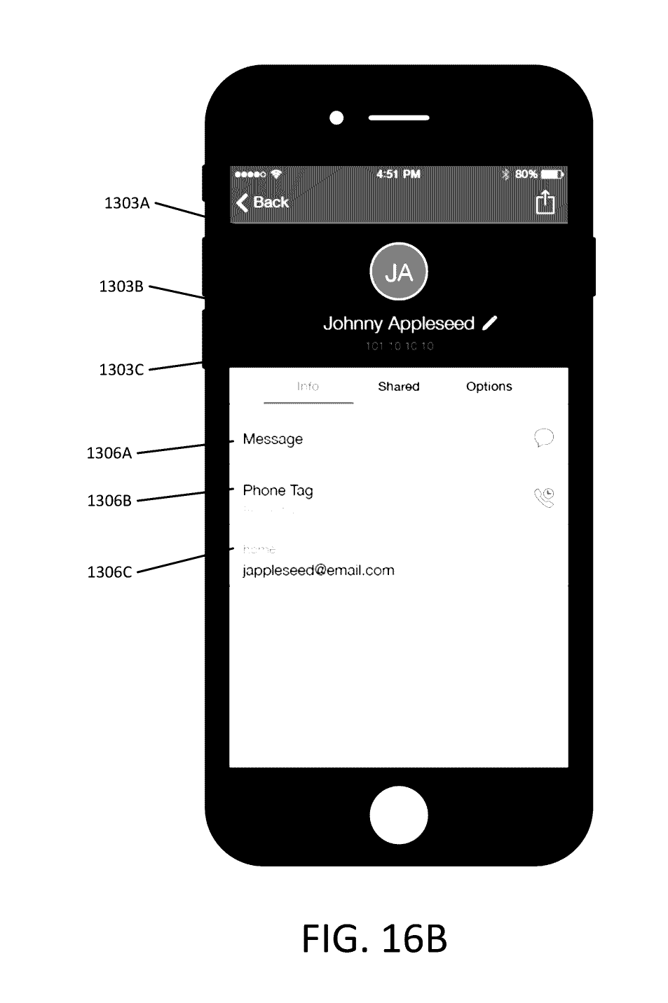

FIG. 16A shows an example user interface for showing a first app user's own updated content item on an app client of the first app user. FIG. 16B shows an example user interface for showing the first app user's updated content item in an app client of a second app user. In the example of FIG. 16A, the first app user has edited the ‘home’ email address from ‘johnny@email.com’ as displayed in FIG. 13A to ‘jappleseed@email.com’ as displayed in FIG. 16A. As a result, as shown in FIG. 16B, the ‘home’ email address displayed on the second app user's app client has also been updated to ‘jappleseed@email.com.” This process happens without the second app user having to take any action. Further, the second app user no longer has access to the email address ‘johnny@email.com.”

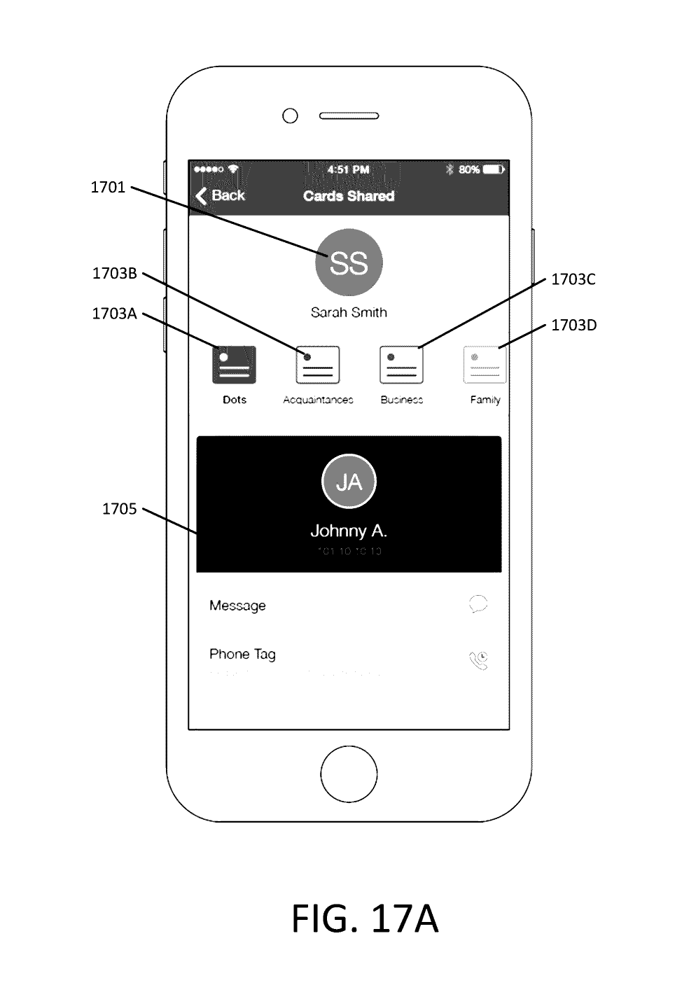

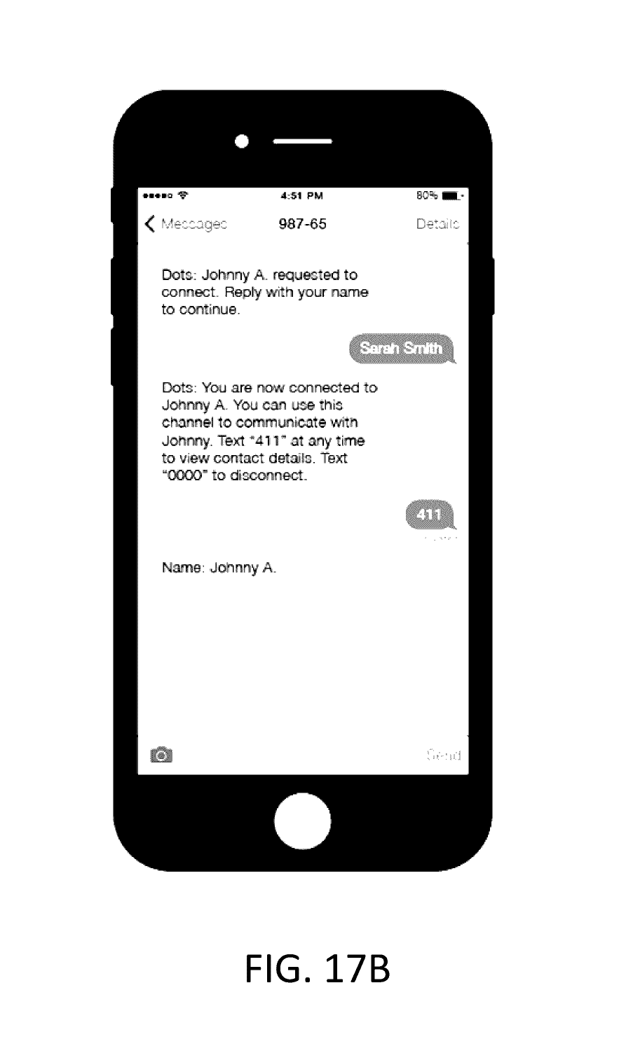

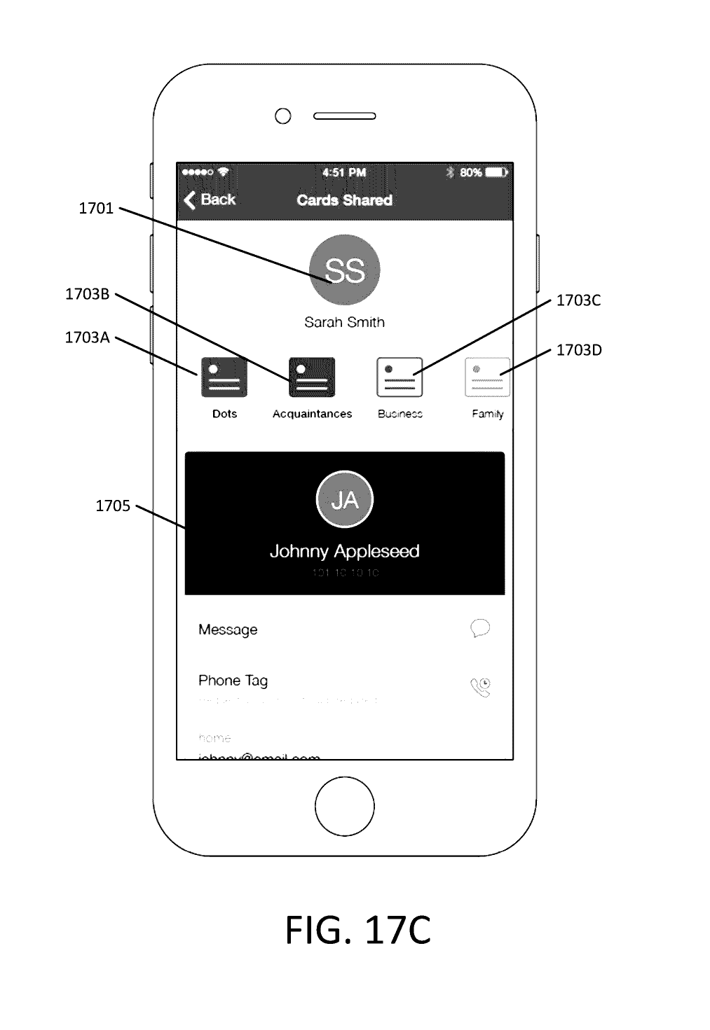

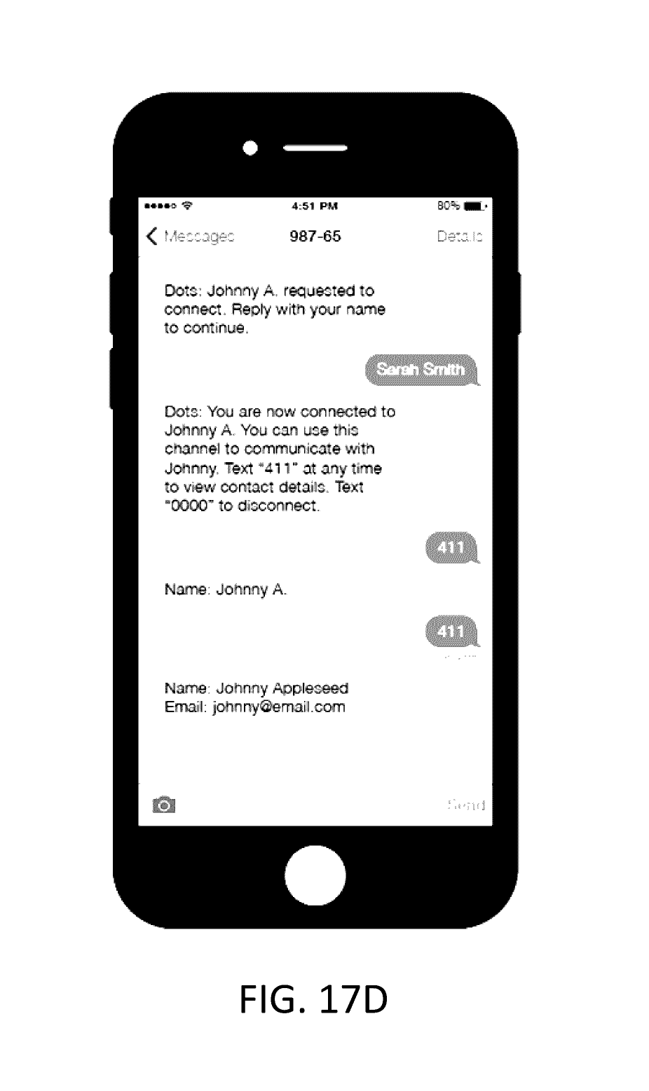

FIG. 17A shows an example user interface for displaying and editing the content groups to which a connected user has been assigned. UI element 1701 indicates the identity of the connected user. UI elements 1703A-D display the content groups to which the connected user may be assigned. UI element 1703A is filled with a solid color, indicating that the user has been assigned to the “Dots” content group. Content item card 1705 displays the content items and options for initiating a communication event that are displayed to the connected user if the user is an app user. FIG. 17C shows the example user interface of FIG. 17A, but with UI element 1703B indicating that the user has been assigned to the “Acquaintances” content group.

FIG. 17B shows an example message screen displaying information shared by a user to an appless user. In this example, the app user ‘Johnny A’ has shared a name with the appless user ‘Sarah Smith.’ The appless user may use the text interface to view the shared name as shown. Content item card 1705 reflects changes in the content items based on the new content group. FIG. 17D illustrates an example message screen similar to the screen of FIG. 17B displaying updated content items. In some embodiments, when a user is assigned to multiple content groups, the list of content items provided to the user contains the content items from each list. However, if the same content item appears on both lists, the content items merge to avoid duplicates and the content item only appears once.

### Example Connection Termination Process

FIG. 18 illustrates an example process for terminating a connection between users of information sharing control. In one embodiment, request module 210 receives 1800 a disconnect request from a user of information sharing control. The disconnect request may be sent via a user interface element. In another embodiment, the disconnect request is sent via a message service or other communication service (e.g. SMS message service). In still another embodiment, the disconnect request is sent automatically upon the happening of an event (i.e. at the expiration of a time period). Connection module 208 determines 1810 the user identifier of the sender of the message from the sender's account record in account data store 220. Connection module 208 accesses 1820 the connection record in connection data store 226. Connection module 208 deletes 1830 the connection record from connection data store 226. Thus, the users associated with the connection record are no longer able to communicate via information sharing control. Because personal contact information (e.g., phone numbers, addresses, etc.) is not shared, users are unable to contact one another once a communication is terminated.

### Additional Considerations

The information sharing control as disclosed provides benefits and advantages that include allowing participants in electronic device communication to control information that is shared during communication. It further allows those participants to control future communication by allowing continuous changes by participants, including changes to whether any piece of information is shared and alterations to the information itself.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1-4. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein, e.g., with respect to FIGS. 5-13C, may be performed, at least partially, by one or more processors, e.g., processor 152, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine but possibly deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other but still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for controlling the information that is shared during electronic communication through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for establishing a connection for controlled communication comprising:
receiving, from a first client associated with a first user, a request to establish controlled communication between the first user and a second user, the request comprising a first user identifier and content handling instructions corresponding to a second user;
transmitting, to the first client, a connection identifier uniquely identifying a connection between the first user and the second user;
receiving, from a second client associated with the second user, a connection message comprising the connection identifier, the second client having a device identifier;
generating a connection record, the connection record comprising a user identifier of the first user, the device identifier, the content handling instructions, and a channel identifier, the channel identifier associated with an electronic communication channel;
transmitting, via the electronic communication channel, a confirmation message to the second client comprising shared contact information of the first user;
determining, from the connection record, the identifier of the first user and the content handling instructions in response to receiving, via the electronic communication channel, a communication message from the device of the second user; and
executing, by the computer, one or more of the content handling instructions.

2. The method of claim 1, wherein the content handling instructions are proscribed by the first user.

3. The method of claim 1, wherein the user identifier of the first user is uniquely assigned to the first user from a plurality of available user identifiers.

4. The method of claim 1, wherein the shared contact information comprises one or more of a plurality of contact information items associated with the first user.

5. The method of claim 4, wherein the content handling instructions specify which, if any, of the plurality of contact information items, is included in the set of contact information.

6. The method of claim 4, wherein each item of the plurality of contact information items associated with the first user is stored in a contact information database and is associated with the user identifier of the first user.

7. The method of claim 3, further comprising:
responsive to receiving the connection message, assigning a second user identifier to the second user from the plurality of available user identifiers.

8. The method of claim 1, further comprising:
determining, from an alternative connection record, the identifier of the first user and alternative content handling instructions, in response to receiving, via the communication channel, a communication message from the device of a third user;
wherein the alternative content handling instructions correspond to the third user;
wherein the alternative content handling instructions are different from the content handling instructions corresponding to the second user; and
executing, by the computer, one or more of the alternative content handling instructions.

9. The method of claim 1, further comprising:
transmitting, via the communication channel, an alternative communication message to the device of a third user comprising alternative shared contact information of the first user;
wherein the alternative shared contact information comprises one or more of a plurality of contact information items associated with the first user; and
wherein the alternative shared contact information is different from the shared contact information.

10. A system for establishing a connection for controlled communication comprising:
a processor configured to execute instructions;
a non-transitory, non-volatile storage medium containing instructions, which when executed by the processor cause the processor to:
receive, from a first client associated with a first user, a request to establish controlled communication between the first user and a second user, the request comprising a first user identifier and content handling instructions corresponding to a second user;
transmit, to the first client, a connection identifier uniquely identifying a connection between the first user and the second user receive, from a second client associated with the second user, a connection message comprising the connection identifier, the second client having a device identifier;
generate a connection record, the connection record comprising a user identifier of the first user, the device identifier, the content handling instructions, and a channel identifier, the channel identifier associated with an electronic communication channel;
transmit, via the electronic communication channel, a confirmation message to the second client comprising shared contact information of the first user;
determine, from the connection record, the identifier of the first user and the content handling instructions in response to receiving, via the electronic communication channel, a communication message from the device of the second user; and
execute, by the computer, one or more of the content handling instructions.

11. The system of claim 10, wherein the content handling instructions are proscribed by the first user.

12. The system of claim 10, wherein the user identifier of the first user is uniquely assigned to the first user from a plurality of available user identifiers.

13. The system of claim 10, wherein the shared contact information comprises one or more of a plurality of contact information items associated with the first user.

14. The system of claim 10, wherein the content handling instructions specify which, if any, of the plurality of contact information items, is included in the set of contact information.

15. The system of claim 13, wherein each item of the plurality of contact information items associated with the first user is stored in a contact information database and is associated with the user identifier of the first user.

16. A computer readable medium configured to store instructions, the instructions when executed by a processor cause the processor to:
receive, from a first client associated with a first user, a request to establish controlled communication between the first user and a second user, the request comprising a first user identifier and content handling instructions corresponding to a second user;
transmit, to the first client, a connection identifier uniquely identifying a connection between the first user and the second user receive, from a second client associated with the second user, a connection message comprising the connection identifier, the second client having a device identifier;
generate a connection record, the connection record comprising a user identifier of the first user, the device identifier, the content handling instructions, and a channel identifier, the channel identifier associated with an electronic communication channel;
transmit, via the electronic communication channel, a confirmation message to the second client comprising shared contact information of the first user;
determine, from the connection record, the identifier of the first user and the content handling instructions in response to receiving, via the electronic communication channel, a communication message from the device of the second user; and
execute, by the computer, one or more of the content handling instructions.

17. The computer readable medium of claim 16, wherein the content handling instructions are proscribed by the first user.

18. The computer readable medium of claim 16, wherein the user identifier of the first user is uniquely assigned to the first user from a plurality of available user identifiers.

19. The computer readable medium of claim 16, wherein the shared contact information comprises one or more of a plurality of contact information items associated with the first user.

20. The computer readable medium of claim 19, wherein the content handling instructions specify which, if any, of the plurality of contact information items, is included in the set of contact information.
